(19) United States
(12) Patent Application Publication
(10) Pub. No.: US 2026/0045209 A1
(43) Pub. Date: Feb. 12, 2026

(54) DISPLAY DEVICE

(71) Applicant: LG Display Co., Ltd., Seoul (KR)

(72) Inventors: Kyeongmin MOON, Paju-si (KR); Jeong Yeon YOON, Paju-si (KR)

(73) Assignee: LG Display Co., Ltd., Seoul (KR)

(21) Appl. No.: 19/286,004

(22) Filed: Jul. 30, 2025

(30) Foreign Application Priority Data
Aug. 12, 2024 (KR) 10-2024-0107733

(51) Int. Cl. G09G 3/32

(52) U.S. Cl. CPC G09G 3/32; G09G 2300/0426; G09G 2310/08; G09G 2320/0233; G09G 2320/0247; G09G 2330/021

(57) ABSTRACT

Embodiments of the present disclosure relate to a display device, and more particularly, to a driver for driving a light emitting device, and a controller for controlling the driver and supplying a plurality of emission clock signals to the driver. The length of a first emission clock signal is different from the length of a second emission clock signal, thereby eliminating a flicker phenomenon.

### CROSS-REFERENCE TO RELATED APPLICATION

This application claims priority to Korean Patent Application No. 10-2024-0107733, filed on Aug. 12, 2024, which is hereby incorporated by reference for all purposes as if fully set forth herein.

### BACKGROUND

### Technical Field

Embodiments of the present disclosure relate to a display device.

### Discussion of the Related Art

A display device is applied to various electronic devices such as televisions, mobile phones, a video phone, a smart watch, a watch phone, a wearable device, a foldable device, a portable multimedia player (PMP), a personal digital assistant(PDA), laptops, and tablets. Display devices include organic light emitting displays (OLEDs) that emit light on their own, liquid crystal displays (LCDs) that require a separate light source, plasma display panel (PDP), electroluminescent display devices, electrowetting display devices, electrophoresis display (EPD) devices, stretchable display devices, flexible display devices, etc.

Recently, display devices with light emitting diodes (LEDs) are attracting attention as next-generation display devices. Since light emitting diodes are made of inorganic materials rather than organic materials, a display device with the light emitting diode has a characteristics of a faster lighting speed, superior light emitting efficiency, and can display high-luminance images compared to a liquid crystal display or an organic light emitting display.

### SUMMARY OF THE DISCLOSURE

Embodiments of the present disclosure can provide a display device capable of preventing flicker phenomenon by controlling the emission time of a light emitting device.

Embodiments of the present disclosure can provide a display device having clear image quality by controlling the emission time of a light emitting device.

Embodiments of the present disclosure can provide a display device capable of low power consumption by controlling the emission time of a light emitting device.

Embodiments of the present disclosure can provide a display device including a light emitting device, a driver configured to drive the light emitting device, and a controller configured to control the driver and supplying a plurality of emission clock signals to the driver, wherein a length of a first emission clock signal is different from a length of a second emission clock signal.

According to embodiments of the present disclosure, it is possible to provide a display device capable of preventing or minimizing flicker phenomenon by controlling the emission time of a light emitting device.

According to embodiments of the present disclosure, it is possible to provide a display device having clear image quality by controlling the emission time of a light emitting device.

According to embodiments of the present disclosure, it is possible to provide a display device capable of low power consumption by controlling the emission time of a light emitting device.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 illustrates a display device according to embodiments of the present disclosure.

FIG. 2 is a plan view of a display device according to embodiments of the present disclosure.

FIG. 3 is a plan view of a display panel according to embodiments of the present disclosure.

FIG. 4 is a plan view of a unit driving area of a display panel according to embodiments of the present disclosure.

FIG. 5 illustrates a subpixel of a display panel according to embodiments of the present disclosure.

FIG. 6 is a plan view of a display panel according to embodiments of the present disclosure.

FIG. 7 and FIG. 8 are plan views of a portion of a display panel according to embodiments of the present disclosure.

FIG. 9 is a cross-sectional view of a display panel according to embodiments of the present disclosure.

FIG. 10 is a detailed cross-sectional view of a display panel according to embodiments of the present disclosure, taken along the A-B cutting line of FIG. 6.

FIG. 11 is an enlarged cross-sectional view of a first subpixel of a display panel according to embodiments of the present disclosure.

FIG. 12 illustrates a subpixel of a display panel according to embodiments of the present disclosure.

FIG. 13 is a timing diagram for a single edge counting mode according to embodiments of the present disclosure.

FIG. 14 is a timing diagram for a dual edge counting mode according to embodiments of the present disclosure.

FIG. 15 is a diagram for frame luminance of one light emitting device ED for one frame period according to embodiments of the present disclosure.

FIG. 16 is a diagram for emission clock dithering according to embodiments of the present disclosure.

FIG. 17 is a diagram for emission clock dithering according to embodiments of the present disclosure.

FIG. 18 is a diagram for gamma primes for each grayscale according to embodiments of the present disclosure.

FIG. 19 is a diagram for gamma primes included in a first gamma prime tap according to embodiments of the present disclosure.

FIG. 20 and FIG. 21 are diagrams for gamma prime allocation order according to embodiments of the present disclosure.

FIG. 22 illustrates a table for explaining the emission clock dithering shift according to embodiments of the present disclosure.

FIG. 23 illustrates a table for explaining the emission clock dithering shift according to embodiments of the present disclosure.

FIG. 24 illustrates a table for explaining the emission clock dithering shift according to embodiments of the present disclosure.

### DETAILED DESCRIPTION OF THE EMBODIMENTS

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description can make the subject matter in some embodiments of the present invention rather unclear. The terms such as “including”, “having”, “comprising”, “containing”, “constituting” “make up of”, and “formed of” used herein are generally intended to allow other components to be added unless the terms are used with the term such as “merely”, “only” etc. As used herein, singular forms are intended to include plural forms unless the context clearly indicates otherwise.

Terms, such as “first”, “second”, “A”, “B”, “(A)”, or “(B)” can be used herein to describe elements of the present invention. Each of these terms is not used to define essence, order, sequence, or number of elements etc., but is used merely to distinguish the corresponding element from other elements.

When it is mentioned that a first element “is connected or coupled to or attached to”, “contacts or overlaps” etc. a second element, it should be interpreted that, not only can the first element “be directly connected or coupled to or attached to” or “directly contact or overlap” the second element, but a third element can also be “interposed” between the first and second elements, or the first and second elements can “be connected or coupled to or attached to”, “contact or overlap”, etc. each other via a fourth element. Here, the second element can be included in at least one of two or more elements that “are connected or coupled to or attached to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms can be used to describe non-consecutive or non-sequential processes or operations unless the term “directly”or “immediately”is used together.

When the position relation between two parts is described using the terms such as “on”, “upper”, “over”, “above”, “under”, “beneath”, “below”, “lower” and “next to”, one or more parts can be positioned between the two parts unless the terms are used with a term such as “immediately”, “just” or “directly”. The term spatially relative should be understood to include different orientations of the element in use or operation in addition to the orientations shown in the drawings. For example, an element described as “below” or “beneath” another element can be placed “above” another element if the elements shown in the drawings are reversed. Thus, the exemplary term “down” can include both down and up directions.

In addition, when any dimensions (length, width, thickness, area, etc.), ratios, angles, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “may”and vice versa.

Hereinafter, various embodiments of the present disclosure are described in detail with reference to the accompanying drawings. All the components of each display device/apparatus according to all embodiments of the present disclosure are operatively coupled and configured.

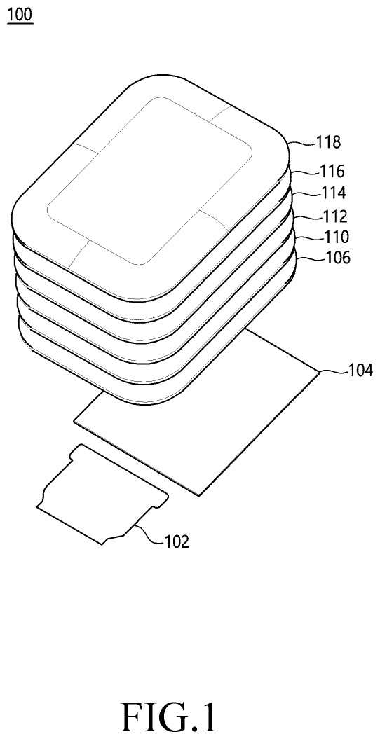

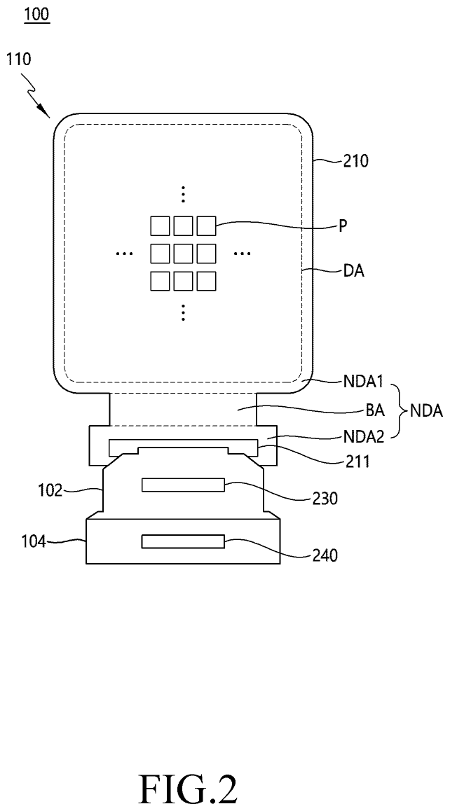

FIG. 1 illustrates a display device 100 according to embodiments of the present disclosure, and FIG. 2 is a plan view of the display device 100 according to embodiments of the present disclosure.

Referring to FIG. 1, the display device 100 according to the embodiments of the present disclosure can include a display panel 110, a cover member 118 disposed on the display panel 110, a flexible printed circuit 102 connected to the display panel 110, and a printed circuit board 104 connected to the flexible printed circuit 102, without limited thereto.

The display device 100 according to the embodiments of the present disclosure can further include a support substrate 106 disposed under the display panel 110 and supporting the lower portion of the display panel 110, a polarizing layer 114 disposed on the display panel 110, a first adhesive layer 112 disposed between the display panel 110 and the polarizing layer 114, and a second adhesive layer 116 disposed between the polarizing layer 114 and the cover member 118, but the present disclosure is not limited thereto.

The display panel 110 can include a substrate 210. The substrate 210 can be a member on which various components such as a plurality of metal layers and a plurality of insulating material layers are formed. The substrate 210 can be made of an insulating material. For example, the substrate 210 can be made of glass or resin. In addition, the substrate 210 can be made of a flexible material. For example, the substrate 210 can be made of a flexible plastic material such as polyimide (PI), polymethylmetacrylicate (PMMA), polycarbonate (PC), polyvinylalcohol (PVA), acryliconitirle-butadiene-styrene (ABS), polyethylene terephthalate (PET), silicone, or polyurethane (PU). However, the embodiments of the present disclosure are not limited thereto.

The display panel 110 can display information, images, and/or images provided to a user. For example, the display panel 110 can include a display area DA and a non-display area NDA. For example, the substrate 210 can include a display area DA and a non-display area NDA. The display area DA and the non-display area NDA are not limited to the substrate 210, but can be described throughout the entire display device 100.

The display area DA can be an area where an image is displayed. The display area DA can include a plurality of pixels P. Each of the plurality of pixels P can be composed of a plurality of subpixels. At least one light emitting device can be arranged in each of the plurality of subpixels. The light emitting device can be configured differently depending on the type of the display device 100. For example, if the display device 100 is an inorganic light emitting display device, the light emitting device can be an inorganic-based light emitting device, such as an inorganic-based light emitting diode (LED), a micro LED, or a mini LED, but the embodiments of the present disclosure are not limited thereto.

The non-display area NDA can be an area where an image is not displayed (e.g., “bezel area”). In the non-display area NDA, various wirings, and circuits for driving a plurality of pixels P of the display area DA can be arranged. For example, various driving circuits and various wirings can be arranged in the non-display area NDA, and a pad section 211 to which an integrated circuit and a printed circuit are connected can be arranged, but the embodiments of the present disclosure are not limited thereto.

For example, the driving circuit can include a data driving circuit and/or a gate driving circuit and/or a sensing circuit, but the embodiments of the present disclosure are not limited thereto. Wires or lines supplied with a control signal for controlling the driving circuit can be arranged on the substrate 210. For example, the control signal can include various timing signals including a clock signal, an input data enable signal, and synchronization signals including horizontal signals and vertical signals, but the embodiments of the present disclosure are not limited thereto. The control signal can be supplied to the substrate 210 from the outside of the substrate 210 through the pad section 211. For example, circuit components such as a flexible printed circuit 102 and a printed circuit board 104 can be connected to the pad section 211.

According to the present embodiments, the non-display area NDA can include a first non-display area NDA1, a bending area BA, and a second non-display area NDA2. For example, the first non-display area NDA1 can be an area surrounding at least a portion of the display area DA. The bending area BA can be an area extending from at least one of a plurality of sides of the first non-display area NDA1 and can be a bendable area. The second non-display area NDA2 can be an area extending from the bending area BA and can include a pad section 211. For example, the bending area BA can be in a bent state, and the remaining area of the substrate 210 excluding the bending area BA can be in a flat state. In this case, as the bending area BA is bent, the second non-display area NDA2 can be located on the back surface of the display area DA. However, the embodiments of the present disclosure are not limited thereto.

The display area DA of the substrate 210 or the display device 100 can be configured in various shapes according to the design of the display device 100. For example, the display area DA can be configured in a rectangular shape with four corners formed in a round shape, but the embodiments of the present disclosure are not limited thereto. For another example, the display area DA can be configured in a rectangular shape with four corners formed in a right angle shape, a circular shape, but the embodiments of the present disclosure are not limited thereto.

According to the embodiments of the present disclosure, a width of the second non-display area NDA2 where the pad section 211 is arranged can be wider than a width of the bending area BA. In addition, a width of the display area DA can be wider than the width of the bending area BA. In the drawing, the width of the bending area BA is depicted as being narrower than the width of other areas of the substrate 210, but the shape of the substrate 210 including the bending area BA is exemplary, and the embodiments of the present disclosure are not limited thereto.

Referring to FIG. 1 and FIG. 2, a flexible printed circuit 102 and a printed circuit board 104 can be disposed at a lower portion of the display panel 110. The flexible printed circuit 102 and the printed circuit board 104 can be arranged at one edge of the display panel 100, but the embodiments of the present disclosure are not limited thereto. One side of the flexible printed circuit 102 can be connected to the display panel 110, and the other side can be connected to the printed circuit board 104, but the embodiments of the present disclosure are not limited thereto. The flexible printed circuit 102 can be a flexible film, but the embodiments of the present disclosure are not limited thereto.

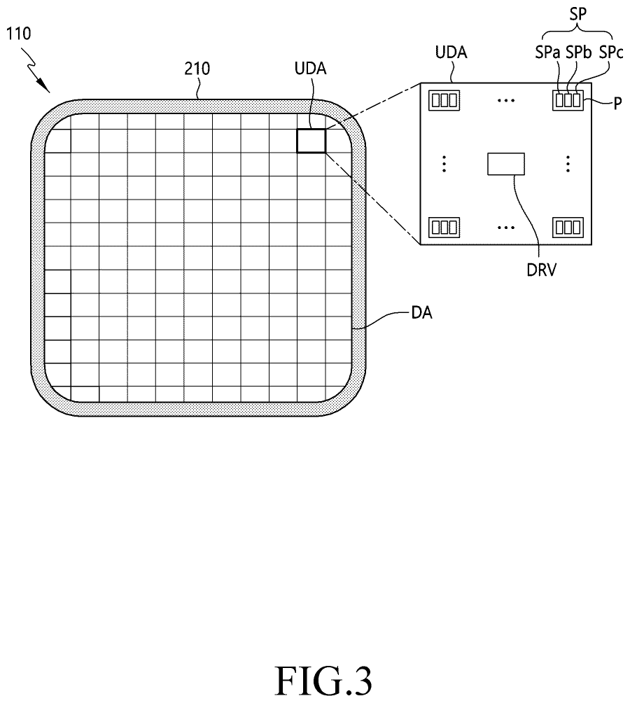

The pad section 211 disposed in the second non-display area NDA2 includes a plurality of pads, and a driving component including one or more flexible printed circuits 102 and a printed circuit board 104 can be attached or bonded. The plurality of pads included in the pad section 211 are electrically connected to one or more flexible printed circuits 102, and can transmit various signals (or power) from the printed circuit board 104 and one or more flexible printed circuits 102 to a driving circuit (for example, a driver DRV of FIG. 3) arranged in the display area DA.

The flexible printed circuit 102 can be a film in which various components are arranged on a flexible base film. For example, a first circuit component 230, such as a gate drive integrated circuit and/or a data drive integrated circuit, can be arranged on one or more flexible printed circuits 102, but the embodiments of the present disclosure are not limited thereto. The first circuit component 230 can be a component that processes data and a driving signal for displaying an image. The first circuit component 230 can be arranged in a manner such as a chip-on-glass (COG), Chip-on-plastic (COP), a chip-on-film (COF), or a tape carrier package (TCP) depending on the mounting method, but the embodiments of the present disclosure are not limited thereto. For example, a gate driving circuit can be mounted as Gate-in-panel (GIP). The flexible printed circuit 102 can be attached or bonded to a plurality of pads through a conductive adhesive layer, but the embodiments of the present disclosure are not limited thereto.

The printed circuit board 104 can be a component that is electrically connected to the flexible printed circuit 102 and supplies a signal to the first circuit component 230. The printed circuit board 104 can be arranged on one side of the flexible printed circuit 102 and can be electrically connected or coupled to the flexible printed circuit 102. Various components for supplying various signals to the first circuit component 230 can be arranged on the printed circuit board 104. For example, various second circuit components 240, such as a timing controller, a power supply, a memory, or a processor, can be arranged on the printed circuit board 104. For example, the second circuit components 240 arranged on the printed circuit board 104 can include a timing controller and/or a power management integrated circuit (PMIC), but the embodiments of the present disclosure are not limited thereto.

The printed circuit board 104 can include at least one hole, but the embodiments of the present disclosure are not limited thereto. An internal component detecting ambient light or temperature, such as a plurality of sensors, can be arranged in an area corresponding to at least one hole. For example, the internal component can include an ambient light sensor (ALS) or a temperature sensor or a humility sensor, but the embodiments of the present disclosure are not limited thereto. For example, the hole can be a transmission hole, but the embodiments of the present disclosure are not limited thereto.

Referring to FIG. 1, a polarizing layer 114 can be arranged on a display panel 110 and can prevent or reduce light generated from an external light source from entering the display panel 110 and affecting a light emitting device.

A cover member 118 can be arranged on a polarizing layer 114 and can be a member for protecting the display panel 110.

A second adhesive layer 116 can be disposed between the polarizing layer 114 and the cover member 118. The second adhesive layer 116 can attach the cover member 118 to the display panel 110 or the polarizing layer 114.

A first adhesive layer 112 can be disposed between the display panel 110 and the polarizing layer 114. The first adhesive layer 112 can attach the polarizing layer 114 to the display panel 110. The first adhesive layer 112 can be omitted.

Each of the first adhesive layer 112 and the second adhesive layer 116 can include an optically clear adhesive (OCA), optically clear resin (OCR), a pressure sensitive adhesive (PSA), an epoxy resin, an acrylic resin, a silicone resin, or a urethane resin, or the like, but the embodiments of the present disclosure are not limited thereto.

The support substrate 106 is disposed between the display panel 110 and the printed circuit board 104 to reinforce the rigidity of the display panel 110. The support substrate 106 can be a back plate, but the embodiments of the present disclosure are not limited thereto.

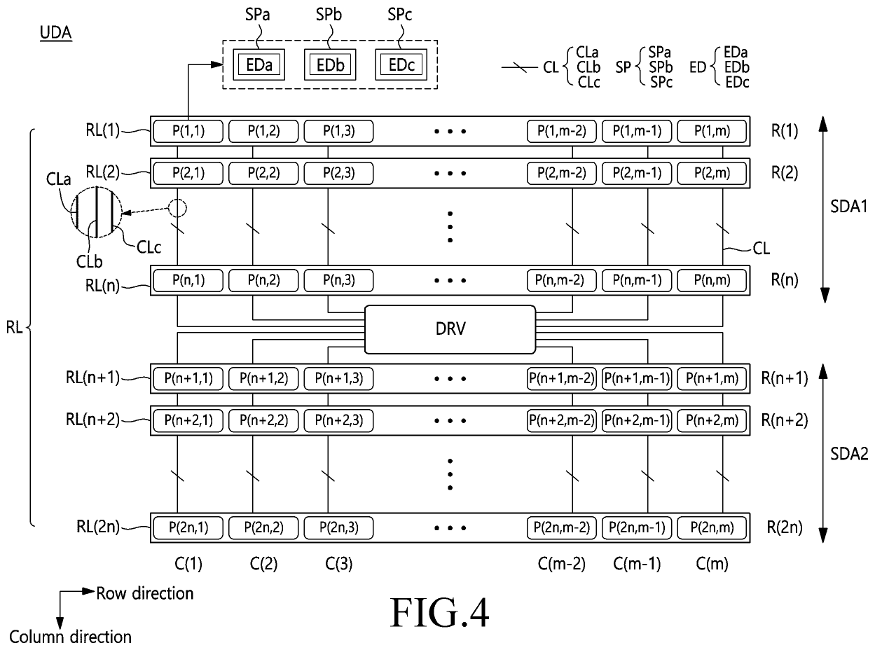

FIG. 3 is a plan view of a display panel 110 according to embodiments of the present disclosure, and FIG. 4 is a plan view of a unit driving area UDA of a display panel 110 according to embodiments of the present disclosure.

Referring to FIG. 3, the display area DA of the display panel 110 according to the embodiments of the present disclosure can include a plurality of unit driving areas UDA.

The display panel 110 according to the embodiments of the present disclosure can include a driver DRV arranged in each of the plurality of unit driving areas UDA. For example, the driver DRV can be a driving chip manufactured using a MOSFET (Metal-oxide-silicon field effect transistor) or BJT (Bipolar junction transistor) manufacturing process on a semiconductor substrate, but the embodiments of the present disclosure are not limited thereto.

Each of the plurality of unit driving areas UDA can be a driving area driven by one driver DRV. For example, the plurality of unit driving areas UDA can be independent driving areas driven by different drivers DRV.

The display panel 110 according to the embodiments of the present disclosure can include a substrate 210 including a display area DA, and a plurality of pixels P arranged in a matrix form in the display area DA.

A plurality of pixels P can be arranged in each of the plurality of unit driving areas UDA. Each of the plurality of pixels P can include a plurality of subpixels SP. Each of the plurality of subpixels SP can include at least one light emitting device.

For example, the plurality of subpixels SP can include a first subpixel SPa, a second subpixel SPb, and a third subpixel SPc, but is not limited thereto. The first subpixel SPa can include a first light emitting device that emits a first color light, the second subpixel SPb can include a second light emitting device that emits a second color light, and the third subpixel SPc can include a third light emitting device that emits a third color light. For example, the first color light, the second color light, and the third color light can be red light, green light, and blue light, respectively, but are not limited thereto. Alternatively, the first color light, the second color light, and the third color light can be be cyan, magenta and yellow light. Alternatively, the plurality of subpixels SP can include more than three subpixels that emit more than three colors.

Referring to FIG. 4, the display panel 110 according to the embodiments of the present disclosure can include a plurality of light emitting devices ED. Each of the plurality of subpixels SP can include a light emitting device ED.

For example, the first subpixel SPa can include a first light emitting device EDa, the second subpixel SPb can include a second light emitting device EDb, and the third subpixel SPc can include a third light emitting device EDc.

The display panel 110 according to the embodiments of the present disclosure can include a plurality of row lines RL and a plurality of column lines CL.

Each of the plurality of row lines RL can be arranged to extend in a row direction. The plurality of row lines RL can be electrically connected to a first electrode of each of a plurality of light emitting devices ED.

Each of the plurality of column lines CL can be arranged to extend in a column direction. The plurality of column lines CL can be electrically connected to a second electrode of each of the plurality of light emitting device ED.

For example, the first electrode of each of the plurality of light emitting device ED can be an anode electrode, and the second electrode of each of the plurality of light emitting device ED can be a cathode electrode. For another example, the first electrode of each of the plurality of light emitting device ED can be a cathode electrode, and the second electrode of each of the plurality of light emitting device ED can be an anode electrode.

Each of the plurality of row lines RL can be electrically connected to the second electrode of each of the plurality of light emitting device ED. For example, the second electrodes of each of the plurality of light emitting device ED can be commonly connected to one row line RL.

Each of the plurality of column lines CL can be electrically connected to the first electrode of each of the plurality of light emitting device ED. For example, the first electrode of each of the plurality of light emitting device ED can be commonly connected to one column line CL.

The line width of each of the plurality of row lines RL can be greater than the line width of each of the plurality of column lines CL.

The display panel 110 according to the embodiments of the present disclosure can include a plurality of drivers DRV. The plurality of drivers DRV can drive the plurality of light emitting device ED, the plurality of column lines CL, and the plurality of row lines RL.

The plurality of drivers DRV can be built into the display panel 110. The plurality of drivers DRV can be arranged in the display area DA, and can be arranged on the substrate 210. The plurality of drivers DRV can be arranged to correspond to a plurality of unit driving areas UDA. For example, one driver DRV can be arranged in one unit driving area UDA.

Each of the plurality of drivers DRV can drive a plurality of row lines RL and a plurality of column lines CL arranged in a corresponding unit driving area UDA among the plurality of unit driving areas UDA, thereby emitting light from a plurality of light emitting device ED arranged in the corresponding unit driving area UDA.

The plurality of drivers DRV are disposed in the display area DA, and can be positioned closer to the substrate 210 than the plurality of light emitting device ED.

For example, the plurality of row lines RL can be driven sequentially. For another example, the plurality of row lines RL can be driven out of order. For another example, the plurality of row lines RL can be driven simultaneously. For another example, two or more row lines RL among the plurality of row lines RL can be driven simultaneously.

For example, during a specific display driving period, among the plurality of row lines RL arranged in the unit driving area UDA, at least one row line RL can be driven, and the remaining row lines RL may not be driven.

According to the embodiments of the present disclosure, a voltage applied to the row line RL can be referred to as a low-potential voltage, and the low-potential voltage can also be referred to as a row line voltage or a cathode voltage. The low-potential voltage can have various voltage values depending on the driving type or driving state. For example, the low-potential voltage can include a first low-potential voltage, a second low-potential voltage, and a third low-potential voltage. In another example, a voltage applied to the row line RL can be referred to as a high-potential voltage, and the high-potential voltage can also be referred to as a row line voltage or an anode voltage. For example, the low-potential voltage can include a first high-potential voltage, a second high-potential voltage, and a third high-potential voltage.

Driving the row line RL can mean that the first low-potential voltage is supplied to the row line RL. Not driving the row line RL can mean that the second low-potential voltage higher than the first low-potential voltage is supplied to the row line RL. In another example, driving the row line RL can mean that the first high-potential voltage is supplied to the row line RL. Not driving the row line RL can mean that the second high-potential voltage lower than the first high-potential voltage is supplied to the row line RL. Accordingly, the light emitting device ED overlapping with the driven row line RL can emit light, and the light emitting device ED overlapping with the non-driven row line RL may not emit light.

For example, any first row line RL among the plurality of row lines RL can be supplied with a first low-potential voltage during a first period, and can be supplied with a second low-potential voltage higher than the first low-potential voltage during a second period different from the first period. Accordingly, the light emitting devices ED overlapping with the first row line RL can emit light during the first period, and may not emit light during the second period different from the first period. For example, the first period and the second period can be included in one display driving period. For another example, the first period and the second period can be included in different display driving periods.

The structure of one unit driving area UDA will be described in more detail with reference to FIG. 4.

Referring to FIG. 4, as an example, one unit driving area UDA can be divided into a first sub-driving area SDA1 and a second sub-driving area SDA2. As another example, one unit driving area UDA can be divided into three or more sub-driving areas. As another example, one unit driving area UDA may not be divided into two or more sub-driving areas.

One unit driving area UDA can include one driver DRV and (2n×m) pixels P(1, 1), . . . , P(1, m), P(2, 1), . . . , P(2, m), . . . , P(2n, 1), . . . , P(2n, m) driven by one driver DRV.

In the embodiments of the present disclosure, n can be the half total number of rows, or the number of rows in each of the first sub-driving area SDA1 and the second sub-driving area SDA2, or the number of row lines RL in each of the first sub-driving area SDA1 and the second sub-driving area SDA2, or the number of pixel rows in each of the first sub-driving area SDA1 and the second sub-driving area SDA2. m can be the half total number of columns, or the number of columns in each of the first sub-driving area SDA1 and the second sub-driving area SDA2, or the number of column lines CL in each of the first sub-driving area SDA1 and the second sub-driving area SDA2, or the number of pixel columns in each of the first sub-driving area SDA1 and the second sub-driving area SDA2.

In the embodiments of the present disclosure, n can be a natural number greater than or equal to 1, and m can be a natural number greater than or equal to 1.

Here, (2n×m) pixels P(1, 1), . . . , P(1, m), P(2, 1), . . . , P(2, m), . . . , P(2n, 1), . . . , P(2n, m) can be arranged in 2n rows R(1), . . . , R(2n) and m columns C(1), . . . , C(m).

Among (2n×m) pixels P(1, 1), . . . , P(1, m), P(2, 1), . . . , P(2, m), . . . , P(2n, 1), . . . , P(2n, m), (n×m) pixels P(1, 1), . . . , P(1, m), P(2, 1), . . . , P(2, m), . . . , P(n, 1), . . . , P(n, m) arranged in the first to n-th rows R(1), . . . , R(n) can be arranged in the first sub-driving area SDA1.

Among (2n×m) pixels P(1, 1), . . . , P(1, m), P(2, 1), . . . , P(2, m), . . . , P(2n, 1), . . . , P(2n, m), (n×m) pixels P(n+1, 1), . . . , P(n+1, m), P(n+2, 1), . . . , P(n+2, m), . . . , P(2n, 1), . . . , P(2n, m) arranged in the (n+1)-th to the 2n-th row R(n+1), . . . , R(2n) can be arranged in the second sub-driving area SDA2.

One unit driving area UDA can include 2n row lines RL(1), . . . , RL(2n) to drive (2n×m) pixels P(1, 1), . . . , P(1, m), P(2, 1), . . . , P(2, m), . . . , P(2n, 1), . . . , P(2n, m).

Among the 2n row lines RL(1), . . . , RL(2n), the first to n-th row lines RL(1), . . . , RL(n) can be arranged in the first sub-driving area SDA1. Among the 2n row lines RL(1), . . . , RL(2n), the (n+1)-th to the 2n-th row lines RL(n+1), . . . , RL(2n) can be arranged in the second sub-driving area SDA2.

Each of the 2n row lines RL(1), . . . , RL(2n) can overlap with m pixels. For example, the first row line RL(1) can overlap with m pixels P(1, 1), . . . , P(1, m) arranged in the first row R(1). The n-th row line RL(n) can overlap with m pixels P(n, 1), . . . , P(n, m) arranged in the n-th row R(n). The (n+1)-th row line RL(n+1) can overlap with the m pixels P(n+1, 1), . . . , P(n+1, m) arranged in the (n+1)-th row R(n+1). The 2n-th row line RL(2n) can overlap with the m pixels P(2n, 1), . . . , P(2n, m) arranged in the 2nth row R(2n).

For example, the first row line RL(1) can be connected to the k subpixels SPa, SPb and SPc included in each of the m pixels P(1, 1), . . . , P(1, m) arranged in the first row R(1). More specifically, the first row line RL(1) can be connected to the second electrodes of the k light emitting devices EDa, EDb and EDc included in each of the m pixels P(1, 1), . . . , P(1, m) arranged in the first row R(1).

For example, the n-th row line RL(n) can be connected to the k subpixels (e.g., SPa, SPb and SPc) included in each of the m pixels P(n, 1), . . . , P(n, m) arranged in the n-th row R(n). More specifically, the n-th row line RL(n) can be connected to the first electrodes of the k light emitting devices (e.g., EDa, EDb and EDc) included in each of the m pixels P(n, 1), . . . , P(n, m) arranged in the n-th row R(n).

For example, the (n+1)-th row line RL(n+1) can be connected to k subpixels (e.g., SPa, SPb and SPc) included in each of m pixels P(n+1, 1), . . . , P(n+1, m) arranged in the (n+1)-th row R(n+1). More specifically, the (n+1)-th row line RL(n+1) can be connected to first electrodes of k light emitting devices (e.g., EDa, EDb and EDc) included in each of m pixels P(n+1, 1), . . . , P(n+1, m) arranged in the (n+1)-th row R(n+1).

For example, the 2n-th row line RL(2n) can be connected to k subpixels (e.g., SPa, SPb and SPc) included in each of m pixels P(2n, 1), . . . , P(2n, m) arranged in the 2n-th row R(2n). More specifically, the 2n-th row line RL(2n) can be connected to first electrodes of k light emitting devices E(e.g., Da, EDb and EDc) included in each of m pixels P(2n, 1), . . . , P(2n, m) arranged in the 2n-th row R(2n).

One unit driving area UDA can include (m×k×2) column lines CL to drive (2n×m) pixels P(1, 1), . . . , P(1, m), P(2, 1), . . . , P(2, m), . . . , P(2n, 1), . . . , P(2n, m). Here, k is the number of subpixels SP included in one pixel P. In the example of FIG. 4, k is 3. For example, one pixel P can include three subpixels SPa, SPb and SPc.

The first sub-driving area SDA1 can include (m×k) column lines CL to drive (n×m) pixels P(1, 1), . . . , P(1, m), . . . , P(n, 1), . . . , P(n, m) arranged in the first sub-driving area SDA1. In the example of FIG. 4, since k is 3, the first sub-driving area SDA1 can include 3m column lines CL.

In the first sub-driving area SDA1, k column lines (e.g., CLa, CLb and CLb) can be arranged in each of the m columns C(1), . . . , C(m). In the example of FIG. 4, since k is 3, in the first sub-driving area SDA1, each of the m columns C(1), . . . , C(m) can include three column lines CLa, CLb and CLc.

In each of the m columns C(1), . . . , C(m), each of the k column lines CL can be commonly connected to n pixels arranged in the corresponding column. In each of the m columns C(1), . . . , C(m), each of the k column lines CL can be commonly connected to first electrodes of n light emitting devices ED arranged in the corresponding column. In the example of FIG. 4, since k is 3, in each of the m columns C(1), . . . , C(m), three column lines CLa, CLb and CLc can be connected to the first electrodes of the 3n light emitting devices ED included in the n pixels arranged in the corresponding column. For example, in each of the m columns C(1), . . . , C(m), a first column line CLa can be commonly connected to the first electrodes of the n first light emitting devices EDa arranged in the corresponding column. In each of the m columns C(1), . . . , C(m), a second column line CLb can be commonly connected to the first electrodes of the n second light emitting devices EDb arranged in the corresponding column. In each of the m columns C(1), . . . , C(m), a third column line CL3 can be commonly connected to the first electrodes of the n third light emitting devices EDc arranged in the corresponding column.

The second sub-driving area SDA2 can include (m×k) column lines CL to drive (n×m) pixels P(n+1, 1), . . . , P(n+1, m), . . . , P(2n, 1), . . . , P(2n, m) arranged in the second sub-driving area SDA2. In the example of FIG. 4, since k is 3, the second sub-driving area SDA2 can include 3m column lines CL.

In the second sub-driving area SDA2, k column lines CL can be arranged in each of the m columns C(1), . . . , C(m). In the example of FIG. 4, since k is 3, in the second sub-driving area SDA2, each of the m columns C(1), . . . , C(m) can include three column lines CLa, CLb and CLc.

In each of the m columns C(1), . . . , C(m), each of the k column lines CL can be commonly connected to n pixels arranged in the corresponding column. In each of the m columns C(1), . . . , C(m), each of the k column lines CL can be commonly connected to first electrodes of n light emitting devices ED arranged in the corresponding column. In the example of FIG. 4, since k is 3, in each of the m columns C(1), . . . , C(m), three column lines CLa, CLb and CLc can be connected to the first electrodes of the 3n light emitting devices ED included in the n pixels arranged in the corresponding column. For example, in each of the m columns C(1), . . . , C(m), a first column line CLa can be commonly connected to the first electrodes of the n first light emitting devices EDa arranged in the corresponding column. In each of the m columns C(1), . . . , C(m), the second column line CLb can be commonly connected to the first electrodes of the n second light emitting devices EDb arranged in the corresponding column. In each of the m columns C(1), . . . , C(m), the third column line CL3 can be commonly connected to the first electrodes of the n third light emitting devices EDc arranged in the corresponding column.

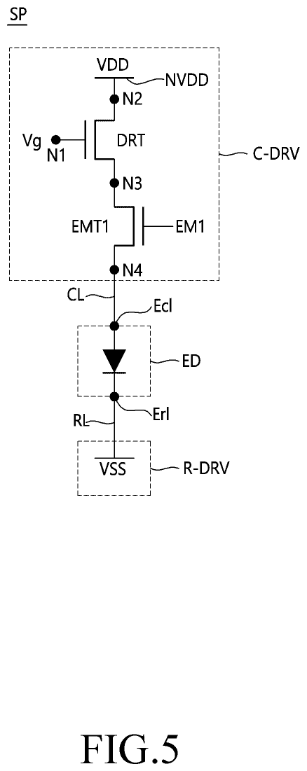

FIG. 5 illustrates a subpixel SP of a display panel 110 according to embodiments of the present disclosure.

Referring to FIG. 5, the subpixel SP according to embodiments of the present disclosure can include a light emitting device ED including a first electrode Ec1 and a second electrode Er1, a column driver C-DRV for driving a column line CL electrically connected to the first electrode Ec1 of the light emitting device ED, and a row driver R-DRV for driving a row line RL electrically connected to the second electrode Er1 of the light emitting device ED.

The light emitting device ED can include a first electrode Ec1 and a second electrode Er1. The first electrode Ec1 can be electrically connected to a column line CL, and the second electrode Er1 can be electrically connected to a row line RL. For example, the first electrode Ec1 can be an anode electrode, and the second electrode Er1 can be a cathode electrode. For another example, the first electrode Ec1 can be a cathode electrode, and the second electrode Er1 can be an anode electrode.

The column driver C-DRV included in a unit driving area UDA can be connected to a plurality of column lines CL included in the unit driving area UDA, and can drive a plurality of column lines CL included in the unit driving area UDA. Each of the plurality of column lines CL can be commonly connected to the first electrode Ec1 of each of the plurality of light emitting devices ED included in the plurality of subpixels SP arranged in the corresponding column.

The row driver R-DRV included in a unit driving area UDA can be connected to a plurality of row lines RL included in the unit driving area UDA and can drive a plurality of row lines RL included in the unit driving area UDA. Each of the plurality of row lines RL can be commonly connected to a second electrode Er1 of each of a plurality of light emitting devices ED included in a plurality of subpixels SP arranged in the corresponding row.

The column driver C-DRV can include main nodes including a first node N1, a second node N2, a third node N3, and a fourth node N4. The column driver C-DRV can include a driving transistor DRT and a first emission control transistor EMT1.

The first node N1 can be a node to which a voltage Vg for controlling the on-off of the driving transistor DRT is applied. The second node N2 can be a node electrically connected to a high-potential voltage node NVDD to which a high-potential voltage VDD is applied. The third node N3 can be a node to which the driving transistor DRT and the first emission control transistor EMT1 are connected. The fourth node N4 can be a node to which the first emission control transistor EMT1 and the light emitting device ED are electrically connected, and can be a node to which the column line CL is electrically connected. Here, a source electrode or a drain electrode of the first emission control transistor EMT1 and the first electrode Ec1 of the light emitting device ED can be commonly connected to the column line CL.

The driving transistor DRT supplies a driving current to make the light emitting device ED emit light, is connected between the second node N2 and the third node N3, and can control the connection between the second node N2 and the third node N3 according to the voltage of the first node N1.

The gate electrode of the driving transistor DRT is electrically connected to the first node N1, and a gate voltage Vg can be applied thereto. The drain electrode or the source electrode of the driving transistor DRT can be electrically connected to the second node N2. The source electrode or the drain electrode of the driving transistor DRT can be electrically connected to the third node N3.

The first emission control transistor EMT1 can control a connection of a path through which the driving current flows, and can play a role in controlling an emission of the light emitting device ED.

If the driving transistor DRT and the first emission control transistor EMT1 are turned on between a high potential voltage VDD and a low potential voltage VSS, the driving current can be supplied to the light emitting device ED through the driving transistor DRT and the first emission control transistor EMT1. Accordingly, the light emitting device ED can emit light.

The first emission control transistor EMT1 is connected between the third node N3 and the fourth node N4, and can control the connection between the third node N3 and the fourth node N4 according to a first emission control signal EM1. The first emission control signal EMI can be applied to the gate electrode of the first emission control transistor EMT1. The drain electrode or the source electrode of the first emission control transistor EMT1 can be electrically connected to the third node N3. The source electrode or drain electrode of the first emission control transistor EMT1 can be electrically connected to the fourth node N4.

The first emission control signal EM1 can be a pulse width modulation signal that varies at a predefined time (for example, each frame, or each sub-frame included in one frame), but the embodiments of the present disclosure are not limited thereto.

The first emission control signal EM1 can be generated by the driver DRV, or can be supplied to the driver DRV from a driving-related circuit such as a timing controller, a host, etc.

The row driver R-DRV can drive at least one row line RL by supplying a low-potential voltage VSS to at least one row line RL.

The row driver R-DRV can perform display-on driving or display-off driving for one row line RL.

The row driver R-DRV can supply a low-potential voltage for display-on driving to one row line RL in order to perform display-on driving for one row line RL. The row driver R-DRV can supply a low-potential voltage for display-off driving to one row line RL in order to perform display-off driving for one row line RL. Alternatively, the row driver R-DRV can supply a high-potential voltage for display-on driving to one row line RL in order to perform display-on driving for one row line RL. The row driver R-DRV can supply a high-potential voltage for display-off driving to one row line RL in order to perform display-off driving for one row line RL.

A low-potential (or high-potential) voltage for display-on driving and a low-potential (or high-potential) voltage for display-off driving can be different. For example, the low-potential (or high-potential) voltage for display-on driving can be lower (or higher) than the low-potential (or high-potential) voltage for display-off driving. In the embodiments of the present disclosure, the “low-potential voltage for display-on driving” is also referred to as the “first low-potential voltage,” and the “low-potential voltage for display-off driving” is also referred to as the “second low-potential voltage.”

The column driver C-DRV can further include at least one switching element and/or at least one transistor in addition to the driving transistor DRT and the first emission control transistor EMT1. Each of the transistors included in the column driver C-DRV can be an n-type transistor or a p-type transistor.

The column driver C-DRV can further include at least one capacitor.

The column driver C-DRV can further include at least one circuit element. For example, the at least one circuit element can include a power output buffer.

The row driver R-DRV can include at least one switching element and/or at least one transistor. Each of the transistors included in the row driver R-DRV can be an n-type transistor or a p-type transistor.

The row driver R-DRV can further include at least one circuit element. For example, at least one circuit element can include a power output buffer.

The column driver C-DRV and the row driver R-DRV can be internal circuits included in the driver DRV. As another example, the column driver C-DRV and the row driver R-DRV may not be included in the driver DRV and can be circuits formed on the substrate 210 of the display panel 110.

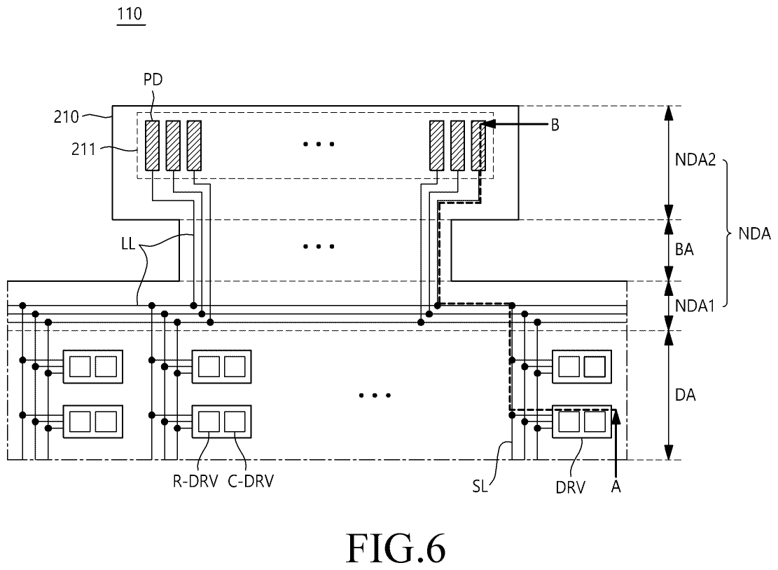

FIG. 6 is a plan view of the display panel 110 according to the embodiments of the present disclosure.

Referring to FIG. 6, the substrate 210 of the display panel 110 according to the embodiments of the present disclosure can include a display area DA and a non-display area NDA, and the non-display area NDA can include a first non-display area NDA1, a bending area BA, and a second non-display area NDA2.

A plurality of drivers DRV can be arranged in the display area DA. Each of the plurality of drivers DRV can be a circuit for driving light emitting devices of a plurality of subpixels included in a corresponding unit driving area (UDA of FIG. 4). Each of the plurality of drivers DRV can include a row driver R-DRV for driving a plurality of row lines and a column driver C-DRV for driving a plurality of column lines, in order to drive a plurality of light emitting devices ED included in a corresponding unit driving area (UDA of FIG. 4).

A pad section 211 including a plurality of pads PD can be arranged in the second non-display area NDA2.

A plurality of signal lines SL and a plurality of link lines LL for signal transmission between a plurality of drivers DRV arranged in the display area DA and the pad section 211 can be arranged on the substrate 210. The plurality of signal lines SL can be electrically connected between the plurality of link lines LL and the plurality of drivers DRV. The plurality of link lines LL can electrically connect the plurality of pads PD and the plurality of signal lines SL.

The plurality of link lines LL can be arranged in the non-display area NDA, and all or part of each of the plurality of signal lines SL can be arranged in the display area DA.

Each of the plurality of drivers DRV can receive various signals to perform a driving operation through the plurality of link lines LL and the plurality of signal lines SL. Here, the various signals can include various power voltages and various signals required for the driving operation of each of the plurality of drivers DRV.

As the bending area BA is bent, a portion of the plurality of link lines LL can also be bent. Stress can be concentrated on a portion of the bent link line LL, and thus cracks can occur in the link line LL. Accordingly, the plurality of link lines LL can be formed of a conductive material having excellent ductility to reduce cracks when the bending area BA is bent. For example, the plurality of link lines LL can be formed of a conductive material having excellent ductility, such as gold (Au), copper (Cu), silver (Ag), aluminum (Al), but the embodiments of the present disclosure are not limited thereto. In addition, the plurality of link lines LL can be composed of one of various conductive materials used in the display area DA. For example, the plurality of link lines LL can be composed of molybdenum (Mo), chromium (Cr), titanium (Ti), aluminum (Al), nickel (Ni), neodymium (Nd), copper (Cu), silver (Ag) and magnesium (Mg), or an alloy thereof, but the embodiments of the present disclosure are not limited thereto. The plurality of link lines LL can be composed of a multilayer structure including various conductive materials. For example, the plurality of link lines LL can be composed of a triple layer structure such as titanium (Ti)/aluminum (Al)/titanium(Ti), aluminum (Al)/molybdenum titanium(MoTi)/aluminum (Al), but the embodiments of the present disclosure are not limited thereto.

The plurality of link lines LL can be composed of various shapes to reduce stress. At least a portion of the plurality of link lines LL arranged on the bending area BA can extend in the same direction as the extension direction of the bending area BA, or can extend in a direction different from the extension direction of the bending area BA to reduce stress. For example, if the bending area BA extends in one direction from the first non-display area NDA1 toward the second non-display area NDA2, at least a portion of the link lines LL arranged on the bending area BA can extend in a direction oblique to the one direction. As another example, at least a portion of the plurality of link lines LL can be configured as patterns of various shapes. For example, at least a portion of the plurality of link lines LL arranged on the bending area BA can be a shape in which conductive patterns having at least one shape among a diamond shape, a rhombus shape, a strip shape, a zig-zag shape, a trapezoidal wave shape, a triangular wave shape, a sawtooth wave shape, a sine wave shape, a circular shape, and an omega (Ω) shape are repeatedly arranged, but the embodiments of the present disclosure are not limited thereto. Therefore, in order to minimize the stress concentrated on the plurality of link lines LL and the resulting cracks, the shapes of the plurality of link lines LL can be formed in various shapes including the shapes described above, but the embodiments of the present disclosure are not limited thereto.

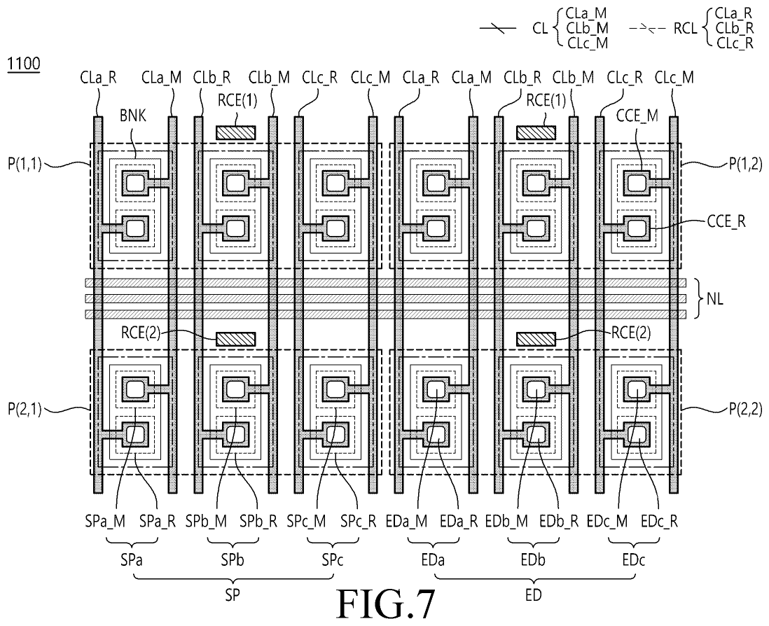

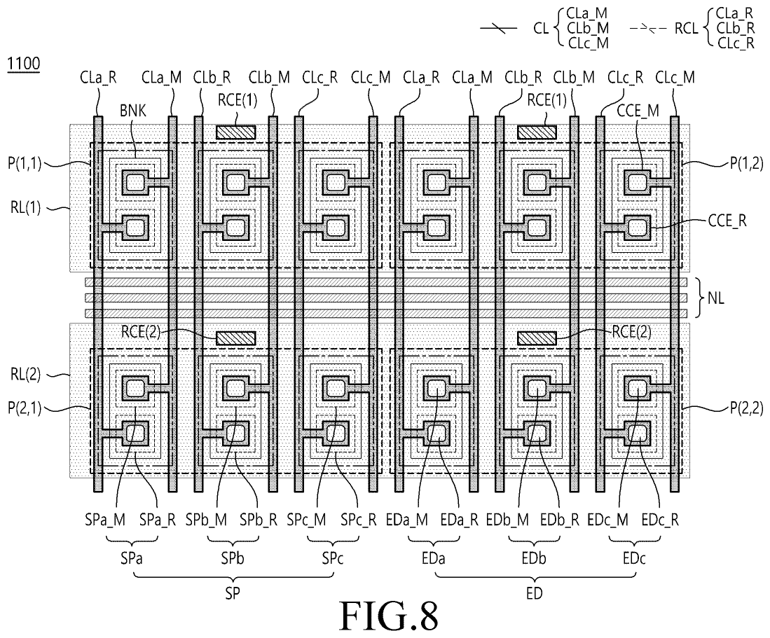

FIG. 7 and FIG. 8 are enlarged plan views of a portion 1100 of a display panel 110, and are enlarged plan views of a two-row, two-column area 1100 according to embodiments of the present disclosure.

Paritulcalry, FIG. 7 is a plan view that does not represent two row lines RL(1) and RL(2) arranged in a two-row, two-column area 1100, and FIG. 8 is a plan view that adds two row lines RL(1) and RL(2) arranged in a two-row, two-column area 1100 to the plan view of FIG. 7.

Referring to FIG. 7 and FIG. 8, in the two-row, two-column area 1100, four pixels P(1,1), P(1,2), P(2,1), P(2,2) can be arranged in two rows and two columns. For example, in the two-row, two-column area 1100, two pixels P(1,1) and P(1,2) can be arranged in a first row (e.g., a first pixel row), and two pixels P(2,1) and P(2,2) can be arranged in a second row (e.g., a second pixel row). In addition, two pixels P(1,1) and P(2,1) can be arranged in a first column (e.g., a first pixel column), and two pixels P(1,2) and P(2,2) can be arranged in a second column (e.g., a second pixel column).

In the two-row, two-column area 1100, each of the four pixels P(1,1), P(1,2), P(2,1) and P(2,2) arranged in two rows and two columns can include k subpixels. Here, k is the number of subpixels included in one pixel.

In FIG. 7 and FIG. 8, a case where k is 3 is as an example. Accordingly, in the two-row, two-column area 1100, each of the four pixels P(1,1), P(1,2), P(2,1) and P(2,2) arranged in two rows and two columns can include three subpixels SPa, SPb and SPc. In the following description, it can be explained assuming the case where k is 3.

The three subpixels can include a first subpixel SPa including a first light emitting device EDa that emits a first color light, a second subpixel SPb including a second light emitting device EDb that emits a second color light, and a third subpixel SPc including a third light emitting device EDc that emits a third color light.

If the display panel 110 according to the embodiments of the present disclosure has a redundancy structure, the subpixel redundancy structure is as follows.

The first subpixel SPa can include a first main subpixel SPa_M including a first main light emitting device EDa_M and a first redundancy subpixel SPa_R including a first redundancy light emitting device EDa_R, the second subpixel SPb can include a second main subpixel SPb_M including a second main light emitting device EDb_M and a second redundancy subpixel SPb_R including a second redundancy light emitting device EDb_R, and the third subpixel SPc can include a third main subpixel SPc_M including a third main light emitting device EDc_M and a third redundancy subpixel SPc_R including a third redundancy light emitting device EDc_R.

If the display panel 110 according to the embodiments of the present disclosure has a redundancy structure, the light emitting device redundancy structure is as follows.

The first light emitting device EDa can include a first main light emitting device EDa_M that emits a first color light and a first redundancy light emitting device EDa_R that emits a first color light, the second light emitting device EDb can include a second main light emitting device EDb_M that emits a second color light and a second redundancy light emitting device EDb_R that emits a second color light, and the third light emitting device EDc can include a third main light emitting device EDc_M that emits a third color light and a third redundancy light emitting device EDc_R that emits a third color light.

In the two-row, two-column area 1100, a first row line RL(1) and a second row line RL(2) can be arranged. The first row line RL(1) can be arranged in the first row (i.e., the first pixel row), and the second row line RL(2) can be arranged in the second row (i.e., the second pixel row).

The first row line RL(1) can correspond to two pixels P(1,1) and P(1,2) arranged in the first row (or the first pixel row), and can correspond to three subpixels SPa, SPb and SPc included in each of the two pixels P(1,1) and P(1,2) arranged in the first row (or the first pixel row).

In terms of the subpixel redundancy structure, the first row line RL(1) can be connected to the first main subpixel SPa_M, the first redundancy subpixel SPa_R, the second main subpixel SPb_M, the second redundancy subpixel SPb_R, the third main subpixel SPc_M, and the third redundancy subpixel SPc_R arranged in the first row (or the first pixel row).

At least a portion of the first row line RL(1) can overlap with the first main subpixel SPa_M, the first redundancy subpixel SPa_R, the second main subpixel SPb_M, the second redundancy subpixel SPb_R, the third main subpixel SPc_M, and the third redundancy subpixel SPc_R arranged in the first row (or the first pixel row).

From the perspective of the light emitting device redundancy structure, the first row line RL(1) can be connected to the second electrode Er1 of each of the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the first row (or the first pixel row).

At least a part of the first row line RL(1) can overlap with the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the first row (or the first pixel row).

The second row line RL(2) can correspond to two pixels P(2,1) and P(2,2) arranged in a second row (or the second pixel row), and can correspond to three subpixels SPa, SPb and SPc included in each of the two pixels P(2,1) and P(2,2) arranged in the second row (or the second pixel row).

In terms of the subpixel redundancy structure, the second row line RL(2) can be connected to the first main subpixel SPa_M, the first redundancy subpixel SPa_R, the second main subpixel SPb_M, the second redundancy subpixel SPb_R, the third main subpixel SPc_M, and the third redundancy subpixel SPc_R arranged in the second row (or the second pixel row).

At least a portion of the second row line RL(2) can overlap with the first main subpixel SPa_M, the first redundancy subpixel SPa_R, the second main subpixel SPb_M, the second redundancy subpixel SPb_R, the third main subpixel SPc_M, and the third redundancy subpixel SPc_R arranged in the second row (or the second pixel row).

In terms of the light emitting device redundancy structure, the second row line RL(2) can be connected to the second electrode Er1 of each of the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the second row (or the second pixel row).

At least a portion of the second row line RL(2) can overlap with the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the second row (or the second pixel row).

A plurality of column lines CL can be arranged in the two-row two-column area 1100. A plurality of column lines CL arranged in a two-row two-column area 1100 can include a plurality of first column lines CL connected to two pixels P(1,1) and P(2,1) arranged in a first column (or a first pixel column), and a plurality of second column lines CL connected to two pixels P(1,2) and P(2,2) arranged in a second column (or a second pixel column).

From the perspective of subpixel redundancy, a plurality of first column lines CL arranged in a first column (or first pixel column) can include a first main column line CLa_M that is commonly connected to a first main subpixel SPa_M included in each of two pixels P(1,1)and P(2,1) arranged in the first column (or first pixel column), and a first redundancy column line CLa_R that is commonly connected to a first redundancy subpixel SPa_R included in each of two pixels P(1,1) and P(2,1) arranged in the first column (or first pixel column).

The first main subpixel SPa_M included in each of the two pixels P(1,1) and P(2,1) arranged in the first column (or the first pixel column) can include a first main light emitting device EDa_M, and the first redundancy subpixel SPa_R included in each of the two pixels P(1,1) and P(2,1) arranged in the first column (or the first pixel column) can include a first redundancy light emitting device (EDa_R).

The first main column line CLa_M arranged in the first column (or the first pixel column) can be commonly connected to the first electrodes Ec1 of the two first main light emitting devices EDa_M arranged in the first column (or the first pixel column).

The first redundancy column line CLa_R arranged in the first column (or the first pixel column) can be commonly connected to the first electrodes Ec1 of two first redundancy light emitting devices EDa_R arranged in the first column (or the first pixel column).

In addition, the plurality of first column lines CL arranged in the first column (or the first pixel column) can further include a second main column line CLb_M commonly connected to a second main subpixel SPb_M included in each of the two pixels P(1,1) and P(2,1) arranged in the first column (or the first pixel column), and a second redundancy column line CLb_R commonly connected to a second redundancy subpixel SPb_R included in each of the two pixels P(1,1) and P(2,1) arranged in the first column (or the first pixel column).

The second main subpixel SPb_M included in each of the two pixels P(1,1) and P(2,1) arranged in the first column (or the first pixel column) can include a second main light emitting device EDb_M, and the second redundancy subpixel SPb_R included in each of the two pixels P(1,1) and P(2,1) arranged in the first column (or the first pixel column) can include a second redundancy light emitting device EDb_R.

The second main column line CLb_M arranged in the first column (or the first pixel column) can be commonly connected to the first electrodes Ec1 of the two second main light emitting devices EDb_M arranged in the first column (or the first pixel column).

The second redundancy column line CLb_R arranged in the first column (or the first pixel column) can be commonly connected to the first electrodes Ec1 of the two second redundancy light emitting devices EDb_R arranged in the first column (or the first pixel column).

In addition, the plurality of first column lines CL arranged in the first column (or the first pixel column) can further include a third main column line CLc_M commonly connected to the third main subpixel SPc_M included in each of the two pixels P(1,1) and P(2,1) arranged in the first column (or the first pixel column), and a third redundancy column line CLc_R commonly connected to the third redundancy subpixel SPc_R included in each of the two pixels P(1,1) and P(2,1) arranged in the first column (or the first pixel column).

The third main subpixel SPc_M included in each of the two pixels P(1,1) and P(2,1) arranged in the first column (or the first pixel column) can include a third main light emitting device EDc_M, and the third redundancy subpixel SPc_R included in each of the two pixels P(1,1) and P(2,1) arranged in the first column (or the first pixel column) can include a third redundancy light emitting device EDc_R.

The third main column line CLc_M arranged in the first column (or the first pixel column) can be commonly connected to the first electrodes Ec1 of the two third main light emitting devices EDc_M arranged in the first column (or the first pixel column).

The third redundancy column line CLc_R arranged in the first column (or the first pixel column) can be commonly connected to the first electrodes Ec1 of two third redundancy light emitting devices EDc_R arranged in the first column (or the first pixel column).

From the perspective of subpixel redundancy, a plurality of second column lines CL arranged in a second column (or second pixel column) can include a first main column line CLa_M that is commonly connected to a first main subpixel SPa_M included in each of two pixels P(1,2) and P(2,2) arranged in the second column (or second pixel column), and a first redundancy column line CLa_R that is commonly connected to a first redundancy subpixel SPa_R included in each of two pixels P(1,2) and P(2,2) arranged in the second column (or second pixel column).

The first main subpixel SPa_M included in each of the two pixels P(1,2) and P(2,2) arranged in the second column (or the second pixel column) can include a first main light emitting device EDa_M, and the first redundancy subpixel SPa_R included in each of the two pixels P(1,2) and P(2,2) arranged in the second column (or the second pixel column) can include a first redundancy light emitting device EDa_R.

The first main column line CLa_M arranged in the second column (or the second pixel column) can be commonly connected to the first electrodes Ec1 of the two first main light emitting devices EDa_M arranged in the second column (or the second pixel column).

The first redundancy column line CLa_R arranged in the second column (or the second pixel column) can be commonly connected to the first electrodes Ec1 of the two first redundancy light emitting devices EDa_R arranged in the second column (or the second pixel column).

In addition, the plurality of second column lines CL arranged in the second column (second pixel column) can further include a second main column line CLb_M commonly connected to a second main subpixel SPb_M included in each of two pixels P(1,2) and P(2,2) arranged in the second column (or second pixel column), and a second redundancy column line CLb_R commonly connected to a second redundancy subpixel SPb_R included in each of two pixels P(1,2) and P(2,2) arranged in the second column (or second pixel column).

The second main subpixel SPb_M included in each of the two pixels P(1,2) and P(2,2) arranged in the second column (or the second pixel column) can include a second main light emitting device EDb_M, and the second redundancy subpixel SPb_R included in each of the two pixels P(1,2) and P(2,2) arranged in the second column (or the second pixel column) can include a second redundancy light emitting device EDb_R.

The second main column line CLb_M arranged in the second column (or the second pixel column) can be commonly connected to the first electrodes Ec1 of the two second main light emitting devices EDb_M arranged in the second column (or the second pixel column).

The second redundancy column line CLb_R arranged in the second column (or the second pixel column) can be commonly connected to the first electrodes Ec1 of two second redundancy light emitting devices EDb_R arranged in the second column (or the second pixel column).

In addition, the plurality of first column lines CL arranged in the second column (or the second pixel column) can further include a third main column line CLc_M commonly connected to a third main subpixel SPc_M included in each of two pixels P(1,2) and P(2,2) arranged in the second column (or the second pixel column), and a third redundancy column line CLc_R commonly connected to a third redundancy subpixel SPc_R included in each of two pixels P(1,2) and P(2,2) arranged in the second column (or the second pixel column).

The third main subpixel SPc_M included in each of the two pixels P(1,2) and P(2,2) arranged in the second column (or the second pixel column) can include a third main light emitting device EDc_M, and the third redundancy subpixel SPc_R included in each of the two pixels P(1,2) and P(2,2) arranged in the second column (or the second pixel column) can include a third redundancy light emitting device EDc_R.

The third main column line CLc_M arranged in the second column (or the second pixel column) can be commonly connected to the first electrodes Ec1 of the two third main light emitting devices EDc_M arranged in the second column (or the second pixel column).

The third redundancy column line CLc_R arranged in the second column (or the second pixel column) can be commonly connected to the first electrodes Ec1 of two third redundancy light emitting devices EDc_R arranged in the second column (or the second pixel column).

In each of the first column (or the first pixel column) and the second column (or the second pixel column), each of the plurality of column lines CL can include at least one column connection electrode having a shape protruding above a bank BNK. For example, the at least one column connection electrode can be an electrode electrically connected to each of the plurality of column lines CL or a portion protruding from each of the plurality of column lines CL.

Each of the first main column line CLa_M, the second main column line CLb_M, and the third main column line CLc_M can include a main column connection electrode CCE_M protruding above the bank BNK and extending above the bank BNK.

The first main light emitting devices EDa_M, the second main light emitting devices EDb_M, and the third main light emitting devices EDc_M can be arranged on the main column connection electrodes CCE_M arranged to extend above the bank BNK.

In each of the first column (or first pixel column) and the second column (or second pixel column), each of the first redundancy column line CLa_R, the second redundancy column line CLb_R, and the third redundancy column line CLc_R can include a redundancy column connection electrode CCE_R that protrudes toward the bank BNK and extends above the bank BNK.

On the redundancy column connection electrodes CCE_R arranged to extend above the bank BNK, the first redundancy light emitting devices EDa_R, the second redundancy light emitting devices EDb_R, and the third redundancy light emitting devices EDc_R can be arranged.

The main column connection electrodes CCE_M and the redundancy column connection electrodes CCE_R arranged in the first sub-pixel column can be disposed between the first main column line CLa_M and the first redundancy column line CLa_R.

The main column connection electrodes CCE_M and the redundancy column connection electrodes CCE_R arranged in the second sub-pixel column can be disposed between the second main column line CLb_M and the second redundancy column line CLb_R.

The main column connection electrodes CCE_M and the redundancy column connection electrodes CCE_R arranged in the third sub-pixel column can be disposed between the third main column line CLc_M and the third redundancy column line CLc_R.

The display panel 110 according to the embodiments of the present disclosure can further include at least one row connection electrode for electrically connecting each of the plurality of row lines RL to the driver DRV.

The display panel 110 according to the embodiments of the present disclosure can further include at least one first row connection electrode RCE(1) connected to a first row line RL(1) arranged in a first row (or a first pixel row), and at least one second row connection electrode RCE(2) connected to a second row line RL(2) arranged in a second row (or a second pixel row).

The first row line RL(1) can be vertically overlapped with at least one first row connection electrode RCE(1), and the second row line RL(2) can be vertically overlapped with at least one second row connection electrode RCE(2).

The first row line RL(1) can be electrically connected to the row driver R-DRV of the corresponding driver DRV through at least one first row connection electrode RCE(1). The second row line RL(2) can be electrically connected to the row driver R-DRV of the corresponding driver DRV through at least one second row connection electrode RCE(2).

According to embodiments of the present disclosure, a bank BNK can be arranged in each of a plurality of subpixels SP. The plurality of banks BNK can be structures on which a plurality of light emitting devices ED are mounted. When manufacturing a panel, in a transfer process for transferring a plurality of light emitting devices ED to a display device 100, a plurality of banks BNK can guide the positions of the plurality of light emitting devices ED. For example, when manufacturing a panel, a plurality of light emitting devices ED can be transferred onto a plurality of banks BNK in a transfer process of the plurality of light emitting devices ED. The plurality of banks BNK can be an organic insulating layer, a bank pattern, or a structure, but the embodiments of the present disclosure are not limited thereto.

The banks BNK of each of the plurality of subpixels SP can be arranged to be spaced apart from each other. The banks BNK of each of the plurality of subpixels SP can be configured to be separated from each other. Accordingly, the banks BNK of the first subpixel SPa, the second subpixel SPb, and the third subpixel SPc to which different types of light emitting devices ED are transferred can be easily identified.

The bank BNK of the first main subpixel SPa_M and the bank BNK of the first redundancy subpixel SPa_R can be connected to each other, or can be formed spaced apart from each other or separately. For example, considering the design of the transfer process requirements, the bank BNK of the first main subpixel SPa_M and the bank BNK of the first redundancy subpixel SPa_R, in which light emitting devices EDa_M, EDa_R of the same type (for example, types that emit the same color light) are arranged, can be connected to each other, or can be formed spaced apart from each other or separately. In addition, the bank BNK of the second main subpixel SPb_M and the bank BNK of the second redundancy subpixel SPb_R, in which light emitting devices EDb_M, EDb_R of the same type (for example, types that emit the same color light) are arranged, can be connected to each other, or can be formed spaced apart from each other or separately. The bank BNK of the third main subpixel SPc_M and the bank BNK of the third redundancy subpixel SPc_R, in which light emitting devices EDc_M, EDc_R of the same type (for example, types that emit the same color light) are arranged, can be connected to each other, or can be formed to be spaced apart from each other or separated from each other.

The bank BNK of the first main subpixel SPa_M and the first redundancy subpixel SPa_R, the bank BNK of the second main subpixel SPb_M and the second redundancy subpixel SPb_R, and the bank BNK of the third main subpixel SPc_M and the third redundancy subpixel SPc_R can be formed in various ways, and the embodiments of the present disclosure are not limited thereto.

For example, the plurality of banks BNK can be formed of an organic insulating material. The plurality of banks BNK can be formed of a single layer or multiple layers of an organic insulating material. For example, the plurality of banks BNK can be composed of acrylic resin, phenolic resin, unsaturated polyester resin, polyamide resin, benzocyclobutene, polyphenylene resin, polyphenylene sulfide resin, photo resist, polyimide (PI), or acrylic material, but the embodiments of the present disclosure are not limited thereto.

The plurality of row lines RL can be formed of a transparent conductive material, but the embodiments of the present disclosure are not limited thereto. The plurality of row lines RL can be composed of a transparent conductive material so that light emitted from the light emitting devices ED can be directed upward through the row lines RL. For example, the plurality of row lines RL can be composed of a transparent conductive material such as indium tin oxide (ITO), indium gallium oxide (IGO), indium zinc oxide (IZO), indium gallium zinc oxide (IGZO), and the like, but the embodiments of the present disclosure are not limited thereto.

The plurality of column lines CL can be made of a conductive material. For example, the plurality of column lines CL can be formed of a conductive material such as titanium (Ti), aluminum (Al), copper (Cu), molybdenum (Mo), nickel (Ni), chromium (Cr), indium tin oxide (ITO), indium gallium oxide (IGO), indium zinc oxide (IZO), indium gallium zinc oxide (IGZO), but the embodiments of the present disclosure are not limited thereto. For another example, the plurality of column lines CL can have a multilayer structure of conductive materials. For example, the plurality of column lines CL can be made of a multilayer structure of titanium (Ti)/aluminum (Al)/titanium (Ti)/indium tin oxide (ITO), indium tin oxide (ITO)/aluminum (Al)/indium tin oxide (ITO), ITO/APC/ITO, but the embodiments of the present disclosure are not limited thereto.

For example, if the light emitting device ED is a device manufactured through a semiconductor process, such as a micro LED, a plurality of light emitting devices ED can be formed on a wafer and the light emitting devices ED can be transferred to a substrate 210 of the display panel 110 to manufacture the display panel 110. In the process of transferring a plurality of light emitting devices ED having a microscopic size from the wafer to the substrate 210, various defects can occur. For example, a non-transfer defect can occur in which the light emitting device ED is not transferred in some subpixels SP, and a misalignment defect can occur in which the light emitting device ED is transferred out of its proper position due to an alignment error in other subpixels SP. In addition, the transfer process can proceed normally, but the transferred light emitting device ED itself can have a defect. Therefore, considering the defects (including non-transfer defects) that occur during the transfer process of the light emitting devices EDs, the main light emitting device and the redundancy light emitting device, which are light emitting devices of the same type (e.g., light emitting devices that emit light of the same color), can be transferred to one subpixel SP. A lighting test can be performed on the main light emitting device and the redundancy light emitting device of the same type, and it is possible to utilize only one of the main light emitting device and the redundancy light emitting device that is finally determined to be normal.

For example, the first main light emitting device EDa_M and the first redundancy light emitting device EDa_R can be transferred together to one first subpixel SPa, and the first main light emitting device EDa_M and the first redundancy light emitting device EDa_R can be inspected for defects. If, as a result of the inspection, both the first main light emitting device EDa_M and the first redundancy light emitting device EDa_R are determined to be normal, only the first main light emitting device EDa_M can be used, and the first redundancy light emitting device EDa_R can be not used. If, as a result of the inspection, only the first redundancy light emitting device EDa_R among the first main light emitting device EDa_M and the first redundancy light emitting device EDa_R is normal, the first main light emitting device EDa_M is not used, and only the first redundancy light emitting device EDa_R can be used. Accordingly, even if the same first main light emitting device EDa_M and the first redundancy light emitting device EDa_R are transferred to one first subpixel SPa, only one of the first main light emitting device EDa_M and the first redundancy light emitting device EDa_R can be used finally.

Accordingly, among the main light emitting device and the redundancy light emitting device arranged in one subpixel SP, the redundancy light emitting device can be a spare light emitting device transferred in preparation for a failure of the main light emitting device. In the event of a failure of the main light emitting device, the redundancy light emitting device can be used as a replacement. Therefore, by transferring the main light emitting device and the redundancy light emitting device together to one subpixel SP, it is possible to minimize or at least reduce the deterioration of display quality due to a defect in one of the main light emitting device and the redundancy light emitting device.

In the embodiments of the present disclosure, the first main subpixel SPa_M and the first redundancy subpixel SPa_R can also be referred to as a 1 -1 subpixel and a 1-2 subpixel, respectively, the second main subpixel SPb_M and the second redundancy subpixel SPb_R can also be referred to as a 2-1 subpixel and a 2-2 subpixel, and the third main subpixel SPc_M and the third redundancy subpixel SPc_R can also be referred to as a 3-1 subpixel and a 3-2 subpixel, respectively.

In the embodiments of the present disclosure, the first main light emitting device EDa_M and the first redundancy light emitting device EDa_R can also be referred to as a 1 -1 light emitting device and a 1-2 light emitting device, the second main light emitting device EDb_M and the second redundancy light emitting device EDb_R can also be referred to as a 2-1 light emitting device and a 2-2 light emitting device, and the third main light emitting device EDc_M and the third redundancy light emitting device EDc_R can also be referred to as a 3-1 light emitting device and a 3-2 light emitting device.

The display panel 110 according to the embodiments of the present disclosure can further include a plurality of communication lines NL. The plurality of communication lines NL can be arranged so as not to overlap with the metal layer in a vertical direction. For example, a plurality of communication lines NL can be arranged between a first row line RL(1) and a second row line RL(2).

For example, the plurality of communication lines NL can be wires for short-range communication such as NFC (Near Field Communication) and Bluetooth. The plurality of communication lines NL can serve as signal transmission wires and/or antennas, but the embodiments of the present disclosure are not limited thereto.

Referring to FIG. 8, the first row line RL(1) can be arranged above a plurality of light emitting devices arranged in the first row (or the first pixel row) and can be arranged in a bar shape overlapping with all of the plurality of light emitting devices arranged in the first row (or the first pixel row).

The second row line RL(2) can be arranged above the plurality of light emitting devices arranged in the second row (or the second pixel row), and can be arranged in a bar shape overlapping with all of the plurality of light emitting devices arranged in the second row (or the second pixel row).

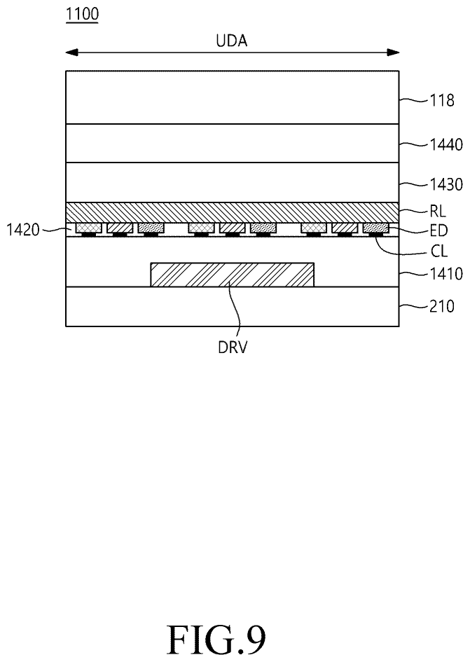

FIG. 9 is a cross-sectional view of a display panel 110 according to embodiments of the present disclosure. However, FIG. 9 is a cross-sectional view of a portion of a unit driving area UDA in which one driver DRV is arranged.

Referring to FIG. 9, a display panel 110 according to embodiments of the present disclosure can include a substrate 210, a driver DRV on the substrate 210, a layer stack 1410 on the driver DRV, a plurality of light emitting devices ED disposed on the layer stack 1410, an optical layer 1420 disposed on the layer stack 1410 and between the plurality of light emitting devices ED, an overcoat layer 1430 disposed on the plurality of light emitting devices ED and the optical layer 1420, an adhesive layer 1440 disposed on the overcoat layer 1430, and a cover member 118 disposed on the adhesive layer 1440.

A plurality of column lines CL can be arranged on a layer stack 1410. Each of the plurality of column lines CL can be arranged between the layer stack 1410 and a light emitting device ED. A plurality of row lines RL can be arranged on a plurality of light emitting devices ED and an optical layer 1420.

A display panel 110 according to embodiments of the present disclosure can include a substrate 210 including a display area DA, a plurality of light emitting devices ED arranged in the display area DA, a plurality of column lines CL electrically connected to first electrodes Ec1 of each of the plurality of light emitting devices ED, a plurality of row lines RL electrically connected to second electrodes Er1 of each of the plurality of light emitting devices ED, and a plurality of drivers DRV configured to drive the plurality of light emitting devices ED, the plurality of column lines CL, and the plurality of row lines RL.

A plurality of drivers DRV can be arranged in the display area DA, and can be positioned closer to the substrate 210 than the plurality of light emitting devices ED.

The layer stack 1410 can include a plurality of insulating layers. The plurality of insulating layers can include a plurality of organic layers. At least one of the plurality of organic layers can be arranged on a side of the driver DRV. For example, two or more organic layers can be arranged on a side of the driver DRV.

The layer stack 1410 can further include at least one metal layer connecting the driver DRV and the column line CL, and at least one metal layer connecting the driver DRV and the row line RL.

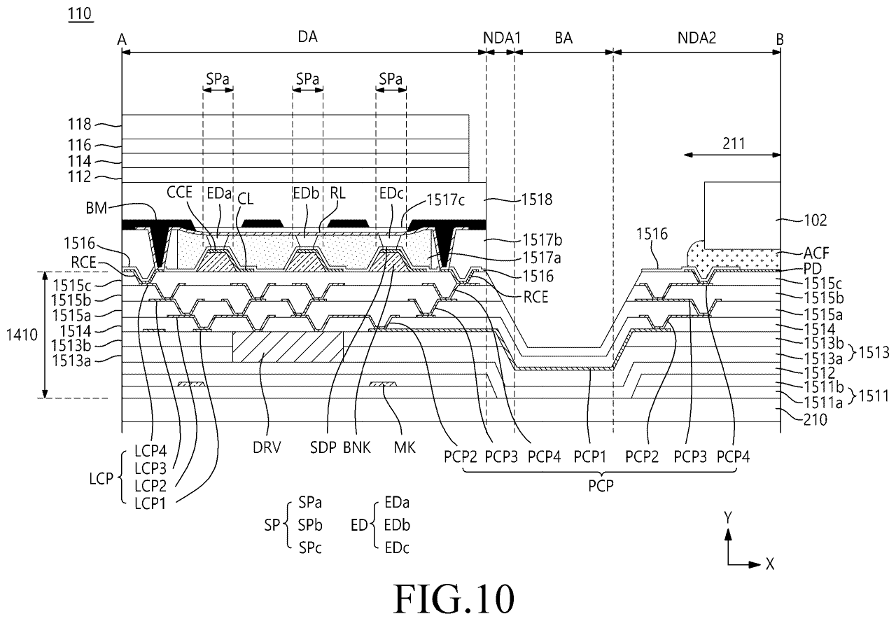

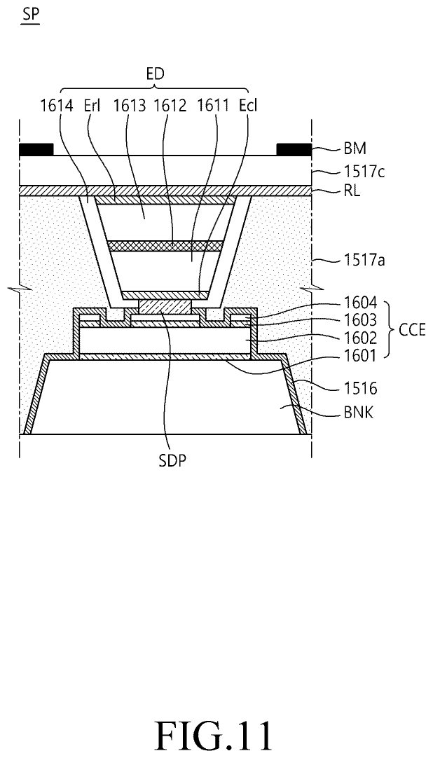

FIG. 10 is a detailed cross-sectional view of a display panel 110 according to embodiments of the present disclosure taken along the A-B cutting line of FIG. 10, and FIG. 11 is an enlarged cross-sectional view of a subpixel SP of a display panel 110 according to embodiments of the present disclosure. However, FIG. 10 is a cross-sectional view of a display area DA, a first non-display area NDA, a bending area BA, and a second non-display area NDA.

Meanwhile, for convenience of illustration, the A-B cutting line in FIG. 6 is illustrated as not overlapping with a signal line SL and a link line LL, but the A-B cutting line in FIG. 10 is intended to indicate the same position as the adjacent signal line SL and the link line LL.

Referring to FIG. 10, a buffer layer 1511 can be included on the substrate 210. The buffer layer 1511 can include a first buffer layer 1511a and a second buffer layer 1511b. The first buffer layer 1511a and the second buffer layer 1511b can be arranged in the display area DA, the first non-display area NDA1, and the second non-display area NDA, and may not be arranged in the entirety or part of the bending area BA. However, the present disclosure is not limited thereto.

The first buffer layer 1511a and the second buffer layer 1511b can reduce the penetration of moisture or impurities through the substrate 210. The first buffer layer 1511a and the second buffer layer 1511b can be made of an inorganic insulating material. For example, the first buffer layer 1511a and the second buffer layer 1511b can be composed of a single layer or multiple layers of silicon oxide (SiOx), silicon nitride (SiNx) or silicon oxynitride (SiOxNy), but the embodiments of the present disclosure are not limited thereto.

For example, a portion of the first buffer layer 1511a and the second buffer layer 1511b on the bending area BA can be removed. The upper surface of the substrate 210 located on the bending area BA can be exposed by the area (e.g., opening) where the first buffer layer 1511a and the second buffer layer 1511b are removed.

By removing the first buffer layer 1511a and the second buffer layer 1511b from the bending area BA, it is possible to minimize or at least reduce an occurrence of cracks in the first buffer layer 1511a and the second buffer layer 1511b that can occur during bending.

A plurality of alignment keys MK can be arranged between the first buffer layer 1511a and the second buffer layer 1511b. The plurality of alignment keys MK can be configured to identify the position of the driver DRV during the manufacturing process of the display panel 110. For example, the plurality of alignment keys MK can be configured to align the position of the driver DRV transferred on the adhesive layer 1512. In another example, the plurality of alignment keys MK can be omitted.

An adhesive layer 1512 can be disposed on the second buffer layer 1511b. The adhesive layer 1512 can be disposed in the display area DA, the first non-display area NDA1, the bending area BA, and the second non-display area NDA2. For another example, at least a portion of the adhesive layer 1512 can be removed in the non-display area NDA including the bending area BA. For example, the adhesive layer 1512 can be made of any one of an adhesive polymer, an epoxy resin, a UV-curable resin, a polyimide series, an acrylate series, a urethane series, and a polydimethylsiloxane (PDMS), but the embodiments of the present disclosure are not limited thereto.

A driver DRV can be disposed on the adhesive layer 1512 in the display area DA. If the driver DRV is implemented as a driving chip (e.g., driver integrated circuit), the driving driver can be mounted on the adhesive layer 1512 by a transfer process, but the embodiments of the present disclosure are not limited thereto.

The display panel 110 can further include a side protection layer 1513 disposed on the side of the plurality of drivers DRV, and an upper protection layer 1514 disposed on the plurality of drivers DRV and the side protection layer 1513. For example, the side protection layer 1513 can include at least one of a first protection layer 1513a and a second protection layer 1513b disposed on the side of the plurality of drivers DRV, and in some cases, can further include at least one additional protection layer. The first protection layer 1513a and the second protection layer 1513b can be disposed on the adhesive layer 1512. The first protection layer 1513a and the second protection layer 1513b can be arranged to surround the side surface of the driver DRV, but the embodiments of the present disclosure are not limited thereto. For example, the second protection layer 1513b can be arranged to cover at least a portion of the upper surface of the driver DRV. For example, at least one of the first protection layer 1513a and the second protection layer 1513b arranged on the bending area BA can be omitted. For example, the first protection layer 1513a can be arranged entirely on the display area DA and the non-display area NDA, and the second protection layer 1513b can be partially arranged on the display area DA, the first non-display area NDA1, and the second non-display area NDA2. For example, at least a portion of the second protection layer 1513b can be removed in all or part of the bending area BA. However, the embodiments of the present disclosure are not limited thereto.

For example, the side protection layer 1513 including at least one of the first protection layer 1513a and the second protection layer 1513b can be composed of an organic insulating material (i.e., organic layer), but the embodiments of the present disclosure are not limited thereto. For example, the first protection layer 1513a and the second protection layer 1513b can be composed of photo resist, polyimide (PI), phenolic resin, unsaturated polyester resin, polyamide resin, benzocyclobutene, polyphenylene resin, polyphenylene sulfide resin or photo acryl-based material, but the embodiments of the present disclosure are not limited thereto. For example, the first protection layer 1513a and the second protection layer 1513b can be an overcoating layer or an insulating layer, but the embodiments of the present disclosure are not limited thereto.

According to embodiments of the present disclosure, in the display area DA, a plurality of line connection patterns LCP can be arranged on the second protection layer 1513b. The plurality of line connection patterns LCP can be wiring for electrically connecting the driver DRV to other components. For example, the driver DRV can be electrically connected to a plurality of column lines CL, a plurality of row lines RL, and a plurality of row connection electrodes RCE through the plurality of line connection patterns LCP.

For example, the plurality of line connection patterns LCP can include a first line connection pattern LCP1, a second line connection pattern LCP2, a third line connection pattern LCP3, and a fourth line connection pattern LCP4, but the embodiments of the present disclosure are not limited thereto. For example, the first line connection pattern LCP1, the second line connection pattern LCP2, the third line connection pattern LCP3, and the fourth line connection pattern LCP4 can be arranged in different metal layers.

For example, a plurality of first line connection patterns LCP1 can be arranged on the second protection layer 1513b. The plurality of first line connection patterns LCP1 can be electrically connected to the driver DRV. The plurality of first line connection patterns LCP1 can transmit the voltage output from the driver DRV to the column line CL or the row line RL.

The display panel 110 can further include a side protection layer 1513 including at least one of the first protection layer 1513a and the second protection layer 1513b, and an upper protection layer 1514 arranged on the plurality of drivers DRV. For example, the upper protection layer 1514 can include a third protection layer 1514, and in some cases, can further include at least one additional protection layer. The third protection layer 1514 can be disposed on the second protection layer 1513b and the plurality of first line connection patterns LCP1. The third protection layer 1514 can be disposed entirely in the display area DA and the non-display area NDA. In the bending area BA, the third protection layer 1514 can cover or enclose the side surface of the second protection layer 1513b and the upper surface of the first protection layer 1513a.

For example, the third protection layer 1514 can be composed of an organic insulating material. For example, the third protection layer 1514 can be composed of phenolic resin, unsaturated polyester resin, polyamide resin, benzocyclobutene, polyphenylene resin, polyphenylene sulfide resin, photo resist, polyimide (PI), or photo acryl-based material, but the embodiments of the present disclosure are not limited thereto. For example, the first protection layer 1513a, the second protection layer 1513b, and the third protection layer 1514 can be composed of the same insulating material, or at least one of the first protection layer 1513a, the second protection layer 1513, and the third protection layer 1514 can be composed of a different insulating material from the rest. However, the embodiments of the present disclosure are not limited thereto.

A plurality of second line connection patterns LCP2 can be arranged on the third protection layer 1514. The plurality of second line connection patterns LCP2 can be electrically connected or directly connected to the driver DRV. For example, some of the second line connection patterns LCP2 can be directly or indirectly connected to the driver DRV through contact holes of the third protection layer 1514. Other parts of the second line connection patterns LCP2 can be electrically connected to the first line connection pattern LCP1 through contact holes of the third protection layer 1514. However, the embodiments of the present disclosure are not limited thereto. The voltage output from the driver DRV can be transmitted to the column line CL or the row line RL through the plurality of second line connection patterns LCP2 and other connection patterns.

A first insulating layer 1515a can be disposed on the plurality of second line connection patterns LCP2. The first insulating layer 1515a can be disposed entirely over the display area DA and the non-display area NDA, but the embodiments of the present disclosure are not limited thereto. The first insulating layer 1515a can be composed of an organic insulating material, but the embodiments of the present disclosure are not limited thereto. For example, the first insulating layer 1515a can be composed of photo resist, polyimide (PI), phenolic resin, unsaturated polyester resin, polyamide resin, benzocyclobutene, polyphenylene resin, polyphenylene sulfide resin or photo acryl-based material, but the embodiments of the present disclosure are not limited thereto.

A plurality of third line connection patterns LCP3 can be disposed on the first insulating layer 1515a. The plurality of third line connection patterns LCP3 can be electrically connected to the plurality of second line connection patterns LCP2. For example, the third line connection pattern LCP3 can be electrically connected to the second line connection pattern LCP2 through a contact hole of the first insulating layer 1515a.

A second insulating layer 1515b can be disposed on a plurality of third line connection patterns LCP3. The second insulating layer 1515b can be disposed in the display area DA, the first non-display area NDA1, and the second non-display area NDA2, and may not be disposed in the entirety or part of the bending area BA, but the embodiments of the present disclosure are not limited thereto. For example, the second insulating layer 1515b can be removed from the entirety or part of the bending area BA. The second insulating layer 1515b can be composed of an organic insulating material, but the embodiments of the present disclosure are not limited thereto. For example, the second insulating layer 1515b can be composed of phenolic resin, unsaturated polyester resin, polyamide resin, benzocyclobutene, polyphenylene resin, polyphenylene sulfide resin, photo resist, polyimide (PI), or photo acryl-based material, but the embodiments of the present disclosure are not limited thereto.

A plurality of fourth line connection patterns LCP4 can be arranged on the second insulating layer 1515b. The plurality of fourth line connection patterns LCP4 can be electrically connected to a plurality of third line connection patterns LCP3. For example, the fourth line connection patterns LCP4 can be electrically connected to the third line connection patterns LCP3 through a contact hole of the second insulating layer 1515b.

Referring to FIG. 10, according to the embodiments of the present disclosure, in the non-display area NDA, a plurality of pad connection patterns PCP can be arranged on the second protection layer 1513b. A plurality of pad connection patterns PCPs can be wiring for transmitting a signal transmitted from a flexible printed circuit 102 to a pad section 211 to a driver DRV of a display area DA. For example, a plurality of pad connection patterns PCP can be electrically connected to a plurality of pads PDs and can receive signals from the flexible printed circuit 102 through the plurality of pads PDs. The flexible printed circuit 102 can be connected to a printed circuit board 104 (see FIGS. 1 and 2).

For example, a plurality of pad connection patterns PCP can extend from the pad section 211 toward the display area DA and transmit signals to the wiring of the display area DA. In this case, a plurality of pad connection patterns PCP can function as link wiring LL (see FIG. 6). The plurality of pad connection patterns PCP can include a first pad connection pattern PCP1, a second pad connection pattern PCP2, a third pad connection pattern PCP3, and a fourth pad connection pattern PCP4.

The plurality of first pad connection patterns PCP1 can be arranged on the second protection layer 1513b. Each of the plurality of first pad connection patterns PCP1 can be arranged across the second non-display area NDA2, the bending area BA, and the first non-display area NDA1. Each of the plurality of first pad connection patterns PCP1 can include a first portion arranged in the bending area BA, a second portion extending from the first portion to the first non-display area NDA1, and a third portion extending from the first portion to the second non-display area NDA2. Each of the plurality of first pad connection patterns PCP1 can extend from the first non-display area NDA1 to a portion of the display area DA. The plurality of first pad connection patterns PCP1 can transmit a signal transmitted from the flexible printed circuit 102 to the pad section 211 to the driver DRV of the display area DA.

Each of the plurality of first pad connection patterns PCP1 can be electrically connected to the pad PD of the pad section 211 through connection patterns arranged in the second non-display area NDA2. Here, the connection patterns electrically connecting each of the plurality of first pad connection patterns PCP1 to the pad PD can include at least one of the second pad connection pattern PCP2, the third pad connection pattern PCP3, and the fourth pad connection pattern PCP4 arranged in the second non-display area NDA2.

Each of the plurality of first pad connection patterns PCP1 can be electrically connected to the driver DRV through connection patterns arranged in the display area DA. Here, the connection patterns electrically connecting each of the plurality of first pad connection patterns PCP1 to the driver DRV can include at least one of the second pad connection pattern PCP2, the third pad connection pattern PCP3, and the fourth pad connection pattern PCP4 arranged in the display area DA.

The plurality of second pad connection patterns PCP2 can be arranged on the third protection layer 1514. The plurality of second pad connection patterns PCP2 can be arranged in the second non-display area NDA2. The second pad connection pattern PCP2 can be electrically connected to the first pad connection pattern PCP1 through a contact hole of the third protection layer 1514. Therefore, the signal supplied from the flexible printed circuit 102 can be transmitted to the first pad connection pattern PCP1 through the second pad connection pattern PCP.

The third pad connection pattern PCP3 can be arranged on the first insulating layer 1515a. The third pad connection pattern PCP3 can be arranged in the second non-display area NDA2. The third pad connection pattern PCP3 can be electrically connected to the second pad connection pattern PCP2 through a contact hole of the first insulating layer 1515a. Therefore, the signal supplied from the flexible printed circuit 102 can be transmitted to the second pad connection pattern PCP2 through the third pad connection pattern PCP3, and the signal transmitted to the second pad connection pattern PCP2 can be transmitted again to the first pad connection pattern PCP1.

The fourth pad connection pattern PCP4 can be arranged on the second insulating layer 1515b. The fourth pad connection pattern PCP4 can be arranged in the second non-display area NDA2. The fourth pad connection pattern PCP4 can be electrically connected to the third pad connection pattern PCP3 through a contact hole of the second insulating layer 1515b. The pad PD of the pad section 211 can be electrically connected to the fourth pad connection pattern PCP4 through a contact hole of the third insulating layer 1515c.

A signal supplied from a flexible printed circuit 102 is input to a pad PD of a pad section 211, and a signal input to the pad PD is transmitted to a third pad connection pattern PCP3 through a fourth pad connection pattern PCP4, and a signal transmitted to the third pad connection pattern PCP3 can be transmitted again to a first pad connection pattern PCP1 through a second pad connection pattern PCP2. A signal transmitted to the first pad connection pattern PCP1 can be transmitted to a driver DRV through connection patterns arranged in a display area DA.

A plurality of line connection patterns LCP and a plurality of pad connection patterns PCP can be arranged in various metal layers. The plurality of line connection patterns LCP and the plurality of pad connection patterns PCP can be formed of any one of a conductive material having excellent ductility or various conductive materials used in a display area DA.

For example, a metal pattern such as a first pad connection pattern PCP1 at least partially disposed in the bending area BA can be composed of a conductive material having excellent ductility, such as gold (Au), silver (Ag), Copper (Cu) or aluminum (Al), but the embodiments of the present disclosure are not limited thereto. For another example, the plurality of line connection patterns LCP and the plurality of pad connection patterns PCP can be composed of molybdenum (Mo), chromium (Cr), titanium (Ti), nickel (Ni), neodymium (Nd), copper (Cu), silver (Ag) or magnesium (Mg), or an alloy thereof, but the embodiments of the present disclosure are not limited thereto.

A third insulating layer 1515c can be disposed on the plurality of line connection patterns LCP and the plurality of pad connection patterns PCP. The third insulating layer 1515c is disposed in the display area DA, the first non-display area NDA1, and the second non-display area NDA2, and can be disposed in all or part of the bending area BA, but the embodiments of the present disclosure are not limited thereto. In the bending area BA, a part of the third insulating layer 1515c can be removed. The third insulating layer 1515c can be composed of an organic insulating material, but the embodiments of the present disclosure are not limited thereto. For example, the third insulating layer 1515c can be composed of phenolic resin, unsaturated polyester resin, polyamide resin, benzocyclobutene, polyphenylene resin, polyphenylene sulfide resin, photo resist, polyimide (PI), or photo acryl-based material, but the embodiments of the present disclosure are not limited thereto.

A plurality of banks BNK can be disposed on the third insulating layer 1515c in the display area DA. The plurality of banks BNKs can be arranged to overlap with at least a portion of each of the plurality of subpixels SPa, SPb and SPc. For example, the first subpixel SPa can include a first light emitting device EDa that emits a first color light, the second subpixel SPb can include a second light emitting device EDb that emits a second color light, and the third subpixel SPc can include a third light emitting device EDc that emits a third color light.

As an example, one light emitting device ED can be arranged on top of each of the plurality of banks BNKs. As another example, two or more light emitting devices ED can be arranged on top of each of the plurality of banks BNK. The two or more light emitting devices EDs arranged on top of each of the plurality of banks BNK can be light emitting devices of the same type. For example, the light emitting devices of the same type can be light emitting devices that emit the same color light. For example, the two or more light emitting devices ED arranged on top of each of the plurality of banks BNK can include a main light emitting device and a redundancy light emitting device.

In the display area DA, a plurality of row connection electrodes RCE can be arranged on the third insulating layer 1515c. The plurality of row connection electrodes RCE can transfer a low-potential voltage VSS output from the driver DRV to the row line RL.

In the display area DA, a plurality of column lines CL can be arranged on the third insulating layer 1515c. The plurality of column lines CL can be arranged in an area between the plurality of banks BNK. For example, the plurality of column lines CL can be arranged adjacent to one of the plurality of banks BNK.

Each of the plurality of column lines CL can include a wiring portion and a column connection electrode CCE protruding from the wiring portion. The wiring portion and the column connection electrode CCE included in each of the plurality of column lines CL can be formed integrally or can be different metals that are electrically connected.

For example, each of the plurality of column lines CL can include a column connection electrode CCE that is a portion protruding above an adjacent bank BNK among the plurality of banks BNK. The column connection electrode CCE of each of the plurality of column lines CL can be arranged to extend along the side and upper surface of the bank BNK. The column connection electrode CCE can be an electrode electrically connected to each of the plurality of column lines CL or can be a portion protruding from each of the plurality of column lines CL.

Referring to FIG. 11, the column connection electrode CCE of the column line CL can be composed of one conductive layer or multiple conductive layers. For example, a column connection electrode CCE electrically connected to a column line CL or protruding from the column line CL can include a first conductive layer 1601, a second conductive layer 1602, a third conductive layer 1603, and a fourth conductive layer 1604, but the embodiments of the present disclosure are not limited thereto.

The first conductive layer 1601 can be disposed on a bank BNK. The second conductive layer 1602 can be disposed on the first conductive layer 1601. The third conductive layer 1603 can be disposed on the second conductive layer 1602, and the fourth conductive layer 1604 can be disposed on the third conductive layer 1603. For example, each of the first conductive layer 1601, the second conductive layer 1602, the third conductive layer 1603, and the fourth conductive layer 1604 can be composed of titanium (Ti), molybdenum (Mo), aluminum (Al), or titanium (Ti) or indium tin oxide (ITO), or an alloy thereof, but the embodiments of the present disclosure are not limited thereto.

According to the embodiments of the present disclosure, among the plurality of conductive layers constituting the column connection electrode CCE, some conductive layers having good reflection efficiency can be configured as an alignment key and/or a reflector for aligning the light emitting devices ED. For example, among the plurality of conductive layers constituting the column connection electrode CCE, the second conductive layer 1602 can include a reflective material. For example, the second conductive layer 1602 can include aluminum (Al), Silver (Ag), gold (Au), magnesium (Mg), calcium (Ca), or barium (B), but the embodiments of the present disclosure are not limited thereto. Accordingly, the second conductive layer 1602 can be configured as a reflector. In addition, due to the high reflection efficiency of the second conductive layer 1602, it can be easily identified in the manufacturing process, and thus the position or transfer position of the light emitting device ED can be aligned based on the second conductive layer 1602.

For example, in order to configure the second conductive layer 1602 as a reflector, the third conductive layer 1603 and the fourth conductive layer 1604 disposed on the second conductive layer 1602 can be partially removed or etched. For example, a portion of the third conductive layer 1603 and the fourth conductive layer 1604 disposed on the bank BNK can be removed or etched to expose the upper surface of the second conductive layer 1602. For example, the openings of the third conductive layer 1603 and the fourth conductive layer 1604 can overlap with a portion of the upper surface of the second conductive layer 1602. For example, in the third conductive layer 1603 and the fourth conductive layer 1604, the central portion and the edge portion where a solder pattern SDP is arranged can remain, and the remaining portions excluding this portion (e.g., the central portion, the edge portion) can be removed. For example, the edge portion of each of the third conductive layer 1603 made of titanium (Ti) and the fourth conductive layer 1604 made of indium tin oxide (ITO) may not be etched. Accordingly, it is possible to prevent or reduce other conductive layers of the column connection electrode CCE of the column line CL from being corroded by the TMAH (Tetra Methyl Ammonium Hydroxide) solution used in the mask process of the column connection electrode CCE.

According to the embodiments of the present disclosure, the first conductive layer 1601 and the third conductive layer 1603 can include titanium (Ti) or molybdenum (Mo). The second conductive layer 1602 can include aluminum (Al), Silver (Ag), gold (Au), magnesium (Mg), calcium (Ca), or barium (B). The fourth conductive layer 1604 can include a transparent conductive oxide layer such as indium tin oxide (ITO), indium gallium oxide (IGO), or indium zinc oxide (IZO) that has good adhesion to the solder pattern SDP and corrosion resistance and acid resistance. However, the embodiments of the present disclosure are not limited thereto.

The first conductive layer 1601, the second conductive layer 1602, the third conductive layer 1603, and the fourth conductive layer 1604 can be sequentially deposited and then patterned by performing a photolithography process and an etching process, but the embodiments of the present disclosure are not limited thereto.

According to embodiments of the present disclosure, two or more of the column connection electrode CCE, the column line CL, the row connection electrode RCE, and the pad PD can be arranged on the same layer. The column connection electrode CCE, the column line CL, the row connection electrode RCE, and the pad PD can be composed of a single layer or multiple layers of a conductive material, but the embodiments of the present disclosure are not limited thereto. For example, two or more of the column connection electrode CCE, the column line CL, the row connection electrode RCE, and the pad PD can be composed of a multiple layer of indium tin oxide (ITO)/titanium (Ti)/aluminum (Al)/titanium (Ti), but the embodiments of the present disclosure are not limited thereto.

According to embodiments of the present disclosure, a solder pattern SDP can be arranged on the column connection electrode CCE in each of a plurality of subpixels. The solder pattern SDP can bond the light emitting device ED to the column connection electrode CCE. The column connection electrode CCE and the light emitting device ED can be electrically connected through eutectic bonding using the solder pattern SDP, but the embodiments of the present disclosure are not limited thereto. For example, if the solder pattern SDP is composed of indium (In) and the first electrode Ec1 of the light emitting device ED is composed of gold (Au), the solder pattern SDP and the first electrode Ec1 of the light emitting device ED can be bonded by applying heat and pressure in a transfer process of the light emitting device ED. Through eutectic bonding, the light emitting device ED can be bonded to the solder pattern SDP and the column connection electrode CCE without a separate adhesive. For example, the solder pattern SDP can be composed of indium (In), tin (Sn), or an alloy thereof, but the embodiments of the present disclosure are not limited thereto. For example, the solder pattern SDP can be a bonding pad, but the embodiments of the present disclosure are not limited thereto.

According to the embodiments of the present disclosure, the passivation layer 1516 can be disposed on a plurality of column lines CL, a plurality of column connection electrodes CCE, a plurality of row connection electrodes RCE, and a third insulating layer 1515c.

For example, the passivation layer 1516 can be disposed on a display area DA, a first non-display area NDA1, and a second non-display area NDA2. In the entirety or a portion of the bending area BA, at least a portion of the passivation layer 1516 covering the plurality of pads PD can be removed. A portion of the passivation layer 1516 covering the plurality of pads PD in the second non-display area NDA2 can be removed. In addition, as illustrated in FIG. 11, the passivation layer 1516 can be removed from the area where the solder pattern SDP is arranged.

Since the passivation layer 1516 is arranged to cover the remaining area except for the bending area BA, the plurality of pads PD, and the area where the solder pattern SDP is arranged, the penetration of moisture or impurities into the light emitting device ED can be reduced. For example, the passivation layer 1516 can be composed of a single layer or multiple layers of silicon oxide (SiOx), silicon nitride (SiNx) or silicon oxynitride (SiOxNy), but the embodiments of the present disclosure are not limited thereto. For example, the passivation layer 1516 can be a protection layer or an insulating layer, but the embodiments of the present disclosure are not limited thereto. For example, as illustrated in FIG. 11, the passivation layer 1516 can include a hole through which the solder pattern SDP is exposed. For example, the hole of the passivation layer 1516 can overlap with the solder pattern SDP.

A light emitting device ED can be arranged on the solder pattern SDP in each of a plurality of subpixels SP. The light emitting device ED can be formed on a silicon wafer by a method such as Metal Organic Chemical Vapor Deposition (MOCVD), Chemical Vapor Deposition (CVD), Plasma-Enhanced Chemical Vapor Deposition (PDCVD), Molecular Beam Epitaxy (MBE), Laser assisted Deposition (LCVD), atomic layer deposition (ALD), Hydride Vapor Phase Epitaxy (HVPD), thermal evaporation, or Sputtering, but the embodiments of the present disclosure are not limited thereto.

The light emitting device ED can include a first electrode Ec1, a first semiconductor layer 1611, an active layer 1612, a second semiconductor layer 1613, a second electrode Er1, and an encapsulation film 1614, but the embodiments of the present disclosure are not limited thereto. For example, the encapsulation film 1614 may not be included in the light emitting device ED.

The first semiconductor layer 1611 can be disposed on the solder pattern SDP. The second semiconductor layer 1613 can be disposed on the first semiconductor layer 1611.

For example, one of the first semiconductor layer 1611 and the second semiconductor layer 1613 can be implemented as a compound semiconductor of group III-V, group II-VI, and can be doped with an impurity (or dopant). For example, one of the first semiconductor layer 1611 and the second semiconductor layer 1613 can be a semiconductor layer doped with an n-type impurity, and the other can be a semiconductor layer doped with a p-type impurity, but the embodiments of the present disclosure are not limited thereto. For example, at least one of the first semiconductor layer 1611 and the second semiconductor layer 1613 can be a layer doped with an n-type or p-type impurity in a material such as gallium nitride (GaN), gallium phosphide (GaP), gallium arsenide phosphide (GaAsP), indium gallium nitride (InGaN), aluminum gallium indium phosphide (AlGaInP), indium aluminum phosphide (InAlP), aluminum gallium nitride (AlGaN), aluminum indium nitride (AlInN), aluminum indium gallium nitride (AlInGaN), aluminum gallium arsenide (AlGaAs), or gallium arsenide (GaAs), but the embodiments of the present disclosure are not limited thereto. For example, the n-type impurity can be silicon (Si), germanium (Ge), selenium (Se), carbon (C), tellurium (Te), or tin (Sn), but the embodiments of the present disclosure are not limited thereto. For example, the p-type impurity can be magnesium (Mg), zinc (Zn), calcium (Ca), strontium (Sr), barium (Ba), or beryllium (Be), but the embodiments of the present disclosure are not limited thereto.

For example, the first semiconductor layer 1611 and the second semiconductor layer 1613 can be a nitride semiconductor including an n-type impurity and a nitride semiconductor including a p-type impurity, respectively, but the embodiments of the present disclosure are not limited thereto. For example, the first semiconductor layer 1611 can be a nitride semiconductor containing a p-type impurity, and the second semiconductor layer 1613 can be a nitride semiconductor containing an n-type impurity, but the embodiments of the present disclosure are not limited thereto.

The active layer 1612 can be arranged between the first semiconductor layer 1611 and the second semiconductor layer 1613. The active layer 1612 can receive holes and electrons from the first semiconductor layer 1611 and the second semiconductor layer 1613 to emit light. For example, the active layer 1612 can be configured as one of a single well structure, a multi-well structure, a single quantum well structure, a multi-quantum well (MQW) structure, a quantum dot structure, and a quantum wire structure, but the embodiments of the present disclosure are not limited thereto. For example, the active layer 1612 can be configured as indium gallium nitride (InGaN), Indium phosphide (InP), Gallium Arsenide (GaAs), Aluminum Gallium Arsenic (AlGaAs) or gallium nitride (GaN), but the embodiments of the present disclosure are not limited thereto.

For another example, the active layer 1612 can include a multi-quantum well (MQW) structure having a well layer and a barrier layer having a higher band gap than the well layer. For example, the active layer 1612 can be formed of InGaN as a well layer and an AlGaN layer as a barrier layer, but the embodiments of the present disclosure are not limited thereto.

The first electrode Ec1 of the light emitting device ED can be arranged between the first semiconductor layer 1611 and the solder pattern SDP. For example, the first electrode Ec1 of the light emitting device ED can electrically connect the first semiconductor layer 1611 and the column connection electrode CCE. The column line voltage (e.g., the anode voltage) output from the driver DRV can be applied to the first semiconductor layer 1611 through the column line CL, the column connection electrode CCE, and the first electrode Ec1. For example, the first electrode Ec1 can be composed of a conductive material capable of eutectic bonding with the solder pattern SDP, but the embodiments of the present disclosure are not limited thereto. For example, the first electrode Ec1 of the light emitting device ED can be composed of gold (Au), tin (Sn), tungsten (W), silicon (Si), silver (Ag), titanium (Ti), iridium (Ir), chromium (Cr), indium (In), zinc (Zn), lead (Pb), nickel (Ni), platinum (Pt), and copper (Cu), or an alloy thereof, but the embodiments of the present disclosure are not limited thereto.

The second electrode Er1 of the light emitting device ED can be disposed on the second semiconductor layer 1613. For example, the second electrode Er1 of the light emitting device ED can electrically connect the second semiconductor layer 1613 and the row line RL. A row line voltage (e.g., referred to as a low-potential voltage VSS as a cathode voltage) output from the driver DRV can be applied to the second semiconductor layer 1613 through the row connection electrode RCE, the row line RL, and the second electrode Er1. The second electrode Er1 of the light emitting device ED can be made of a transparent conductive material so that light emitted from the light emitting device ED can be directed to the upper portion of the light emitting device ED, but the embodiments of the present disclosure are not limited thereto. For example, the second electrode Er1 can be made of a material such as indium tin oxide (ITO), indium zinc oxide (IZO), indium gallium oxide (IGO) or indium gallium zinc oxide (IGZO), but the embodiments of the present disclosure are not limited thereto.

The encapsulation film 1614 can be disposed on at least a portion of the first semiconductor layer 1611, the active layer 1612, the second semiconductor layer 1613, the first electrode Ec1, and the second electrode Er1. For example, the encapsulation film 1614 can surround at least a portion of the first semiconductor layer 1611, the active layer 1612, the second semiconductor layer 1613, the first electrode Ec1, and the second electrode Er1.

For example, the encapsulation film 1614 can protect the first semiconductor layer 1611, the active layer 1612, and the second semiconductor layer 1613. For example, the encapsulation film 1614 can be disposed on a side surface of the first semiconductor layer 1611, a side surface of the active layer 1612, and a side surface of the second semiconductor layer 161.

For example, the encapsulation film 1614 can be disposed on at least a portion of the first electrode Ec1 and the second electrode Er1 of the light emitting device ED. For example, the encapsulation film 1614 can be disposed on an edge portion (or one side) of the first electrode Ec1 of the light emitting device ED and an edge portion (or one side) of the second electrode Er1 of the light emitting device ED. At least a portion of the first electrode Ec1 can be exposed from the encapsulation film 1614 so that the first electrode Ec1 can be connected to the solder pattern SDP. For example, at least a portion of the second electrode Er1 can be exposed from the encapsulation film 1614 so that the second electrode Er1 can be connected to the row line RL. For example, the encapsulation film 1614 can be made of an insulating material such as silicon nitride (SiNx), silicon oxide (SiOx) or silicon oxynitride (SiOxNy), but the embodiments of the present disclosure are not limited thereto.

For another example, the encapsulation film 1614 can have a structure in which a reflective material is dispersed in a resin layer, but the embodiments of the present disclosure are not limited thereto. For example, the encapsulation film 1614 can be manufactured as a reflector of various structures, but the embodiments of the present disclosure are not limited thereto. Light emitted from the active layer 1612 can be reflected upward by the encapsulation film 1614, thereby improving light extraction efficiency. For example, the encapsulation film 1614 can be a reflective layer, but the embodiments of the present disclosure are not limited thereto.

According to the embodiments of the present disclosure, the light emitting device ED is described as having a vertical structure, but the embodiments of the present disclosure are not limited thereto. For example, the light emitting device ED can have a lateral structure or a flip chip structure.

The structure of the light emitting device ED illustrated in FIG. 11 can be substantially equally applied to all of the first light emitting device EDa, the second light emitting device EDb, and the third light emitting device EDc. According to embodiments of the present disclosure, a first optical layer 1517a can be arranged to surround a plurality of light emitting devices ED in the display area DA. For example, the first optical layer 1517a can be arranged to cover or surround a plurality of light emitting devices ED and the bank BNK in the area of a plurality of subpixels SP. For example, the first optical layer 1517a can cover a bank BNK, a portion of the passivation layer 1516, and a region between the plurality of light emitting devices ED. The first optical layer 1517a can be arranged or covered between a plurality of light emitting devices ED included in one pixel and between a plurality of banks BNK. For example, the first optical layer 1517a can be arranged to extend in the first direction (X) and be spaced apart from each other in the second direction (Y). For example, the first optical layer 1517a can be arranged to surround the side of the light emitting devices ED and the banks BNK between the passivation layer 1516 and the row line RL, but the embodiments of the present disclosure are not limited thereto. For example, the first optical layer 1517a can be a diffusion layer or a sidewall diffusion layer, but the embodiments of the present disclosure are not limited thereto.

The first optical layer 1517a can include an organic insulating material having fine particles dispersed therein, but the embodiments of the present disclosure are not limited thereto. For example, the first optical layer 1517a can be composed of siloxane having fine metal particles, such as titanium dioxide (TiO2) particles, silicon oxide (SiO2) particles, dispersed therein, but the embodiments of the present disclosure are not limited thereto. Light from a plurality of light emitting devices ED can be scattered by the fine particles dispersed in the first optical layer 1517a and emitted to the outside of the display device 100. Accordingly, the first optical layer 1517a can improve the extraction efficiency of light emitted from the plurality of light emitting devices ED.

For example, the first optical layer 1517a can be arranged on each of a plurality of pixels, or can be arranged together on some pixels arranged in the same row, but the embodiments of the present disclosure are not limited thereto. For example, the first optical layer 1517a can be arranged on each of a plurality of pixels, or the plurality of pixels can share one first optical layer 1517a. For another example, each of the plurality of subpixels can separately include a first optical layer 1517a, but the embodiments of the present disclosure are not limited thereto.

According to the embodiments of the present disclosure, in the display area DA, a second optical layer 1517b can be arranged on the passivation layer 1516. For example, the second optical layer 1517b can be arranged to surround the first optical layer 1517a. For example, the second optical layer 1517b can be in contact with a side surface of the first optical layer 1517a. For example, the second optical layer 1517b can be arranged in an area between the plurality of pixels. However, the embodiments of the present disclosure are not limited thereto. For example, the second optical layer 1517b can be a diffusion layer, a diffusion layer window, or a window diffusion layer, but the embodiments of the present disclosure are not limited thereto.

The second optical layer 1517b can be composed of an organic insulating material, but the embodiments of the present disclosure are not limited thereto. The second optical layer 1517b can be composed of the same material as the first optical layer 1517a, but the embodiments of the present disclosure are not limited thereto. For example, the first optical layer 1517a can include fine particles, and the second optical layer 1517b may not include fine particles. For example, the second optical layer 1517b can be composed of siloxane, but the embodiments of the present disclosure are not limited thereto.

For example, the thickness of the first optical layer 1517a can be smaller than the thickness of the second optical layer 1517b, but the embodiments of the present disclosure are not limited thereto. Accordingly, when viewed from a planar view, the area where the first optical layer 1517a is disposed can include a concave portion that is sunken inwardly from the upper surface of the second optical layer 1517b.

According to the embodiments of the present disclosure, a row line RL can be disposed on the first optical layer 1517a and the second optical layer 1517b. For example, the row line RL can be electrically connected to a plurality of row connection electrodes RCE through contact holes of the second optical layer 1517b. For example, the row line RL can be disposed on a plurality of light emitting devices ED. For example, the row line RL can include a transparent conductive oxide such as indium tin oxide (ITO), indium gallium oxide (IGO) or indium zinc oxide (IZO), but the embodiments of the present disclosure are not limited thereto. For example, the row line RL can be arranged to be in contact with the second electrode Er1 of the light emitting device ED. For example, the row line RL can overlap with the first optical layer 1517a. For example, the row line RL can cover a plane on the outside of the first optical layer 1517a.

The row line RL can extend continuously in the first direction (X) of the substrate 210. Accordingly, the row line RL can be commonly connected to a plurality of pixels arranged in the first direction (X) of the substrate 210. For example, the row line RL can be commonly connected to a plurality of pixels.

According to the embodiments of the present disclosure, the row line RL can be continuously extended on the first optical layer 1517a, the second optical layer 1517b, and the light emitting device ED. The area where the first optical layer 1517a is disposed can include a concave portion that is sunken inwardly from the upper surface of the second optical layer 1517b. Accordingly, the first part of the row line RL disposed on the first optical layer 1517a can be disposed along the concave portion, and thus can be disposed at a lower position than the second part of the row line RL disposed on the second optical layer 1517b.

A third optical layer 1517c can be disposed on the row line RL. The third optical layer 1517c can be disposed so as to overlap with a plurality of light emitting devices ED and the first optical layer 1517a. Since the third optical layer 1517c is arranged on the row line RL and the plurality of light emitting devices ED, it is possible to improve a mura that can occur in some of the plurality of light emitting devices ED. For example, when transferring a plurality of light emitting devices ED onto the substrate 210 of the display panel 110, there can occur an area where the spacing between the plurality of light emitting devices ED is not uniform due to process deviation. If the spacing between the plurality of light emitting devices ED is not uniform, an emission areas of each of the plurality of light emitting devices ED can be arranged unevenly, and thus a mura can be visible to the user. Accordingly, since the third optical layer 1517c is arranged to uniformly diffuse light over the plurality of light emitting devices ED, it is possible to reduce light emitted from some of the light emitting devices ED from being visible as a mura. Accordingly, since the light emitted from the plurality of light emitting devices EDs is evenly diffused by the third optical layer 1517c and extracted to the outside of the display device 100, the luminance uniformity of the display device 100 can be improved.

The third optical layer 1517c can be composed of an organic insulating material in which fine particles are dispersed, but the embodiments of the present disclosure are not limited thereto. For example, the third optical layer 1517c can be composed of siloxane in which fine metal particles such as titanium dioxide (TiO2) particles, silicon oxide (SiO2) particles, are dispersed, but the embodiments of the present disclosure are not limited thereto. For example, the third optical layer 1517c can be composed of the same material as the first optical layer 1517a, but the embodiments of the present disclosure are not limited thereto. For example, the third optical layer 1517c can be a diffusion layer or an upper diffusion layer, but the embodiments of the present disclosure are not limited thereto.

According to the embodiments of the present disclosure, light from a plurality of light emitting devices ED can be scattered by fine particles dispersed in a third optical layer 1517c and emitted to the outside of the display device 100. The third optical layer 1517c can evenly mix light emitted from a plurality of light emitting devices ED, thereby further improving the luminance uniformity of the display device 100. In addition, the light extraction efficiency of the display device 100 can be improved by the light scattered from the plurality of fine particles, thereby enabling the display device 100 to be driven at low power.

A black matrix BM can be arranged on the row line RL, the first optical layer 1517a, the second optical layer 1517b, and the third optical layer 1517c in the display area DA. For example, the black matrix BM can fill a contact hole of the second optical layer 1517b. The black matrix BM can be configured to cover the display area DA, so that the color mixing of light and external light reflection of the plurality of subpixels can be reduced. For example, the black matrix BM can also be arranged in the contact hole where the row line RL and the row connection electrode RCE are connected, so that light leakage between the neighboring plurality of subpixels can be prevented.

For example, the black matrix BM can be composed of an opaque material, but the embodiments of the present disclosure are not limited thereto. For example, the black matrix BM can be an organic insulating material to which a black pigment or a black dye such as carbon black, Kochen black, nigrosine is added, but the embodiments of the present disclosure are not limited thereto.

A cover layer 1518 can be arranged on the black matrix BM in the display area DA. The cover layer 1518 can protect a configuration under the cover layer 1518. For example, the cover layer 1518 can be composed of an organic insulating material, but the embodiments of the present disclosure are not limited thereto. For example, the cover layer 1518 can be composed of phenolic resin, unsaturated polyester resin, polyamide resin, benzocyclobutene, polyphenylene resin, polyphenylene sulfide resin, photo resist, polyimide (PI), or photo acryl-based material, but the embodiments of the present disclosure are not limited thereto. For example, the cover layer 1518 can be an overcoating layer or an insulating layer, but the embodiments of the present disclosure are not limited thereto.

A polarizing layer 114 can be arranged on the cover layer 1518 via a first adhesive layer 112. A cover member 118 can be arranged on the polarizing layer 114 via a second adhesive layer 116. For example, the first adhesive layer 112 and the second adhesive layer 116 can include an optically clear adhesive (OCA), an optically clear resin (OCR), a pressure sensitive adhesive (PSA), an epoxy resin, an acrylic resin, a silicone resin, or a urethane resin, or the like,, but the embodiments of the present disclosure are not limited thereto.

According to embodiments of the present disclosure, a plurality of pads PD can be arranged on a third insulating layer 1515c in a second non-display area NDA2. For example, at least a portion of the plurality of pads PD can be exposed from a passivation layer 1516. For example, the plurality of pads PD can be electrically connected to a fourth pad connection pattern PCP4 through a contact hole of the third insulating layer 1515c.

An adhesive layer ACF can be arranged on the plurality of pads PD. The adhesive layer ACF can be an adhesive layer in which conductive balls are dispersed in an insulating material, but embodiments of the present disclosure are not limited thereto. When heat or pressure is applied to the adhesive layer ACF, the conductive balls can be electrically connected at a portion where the heat or pressure is applied, thereby having conductive properties. The adhesive layer ACF can be disposed between a plurality of pads PD and a flexible printed circuit 102, so that the flexible printed circuit 102 can be attached or bonded to the plurality of pads PD. For example, the adhesive layer ACF can be an anisotropic conductive film ACF, but the embodiments of the present disclosure are not limited thereto.

A flexible printed circuit 102 can be disposed on the adhesive layer ACF. The flexible printed circuit 102 can be electrically connected to the plurality of pads PD through the adhesive layer ACF. Accordingly, a signal supplied from the flexible printed circuit 102 can be transmitted to a driver DRV of a display area DA through the plurality of pads PD, the fourth pad connection pattern PCP4, the third pad connection pattern PCP3, the second pad connection pattern PCP2, and the first pad connection pattern PCP1.

Referring to FIG. 10, the display panel 110 according to the embodiments of the present disclosure can include a substrate 210, a layer stack 1410 on or beside a plurality of drivers DRV disposed on the substrate 210, a first optical layer 1517a disposed between a plurality of light emitting devices EDa, EDb and EDc on the layer stack 1410, an adhesive layer 116 disposed on the plurality of light emitting devices EDa, EDb and EDc and the first optical layer 1517a, and a cover member 118 disposed on the adhesive layer 116.

A plurality of column lines CL can be disposed between the layer stack 1410 and the plurality of light emitting devices EDa, EDb and EDc.

A plurality of row lines RL can be arranged on a plurality of light emitting devices EDa, EDb and EDc and a first optical layer 1517a. A plurality of row lines RL can be arranged between a plurality of light emitting devices EDa, EDb and EDc, an first optical layer 1517a, and an adhesive layer 116.

A layer stack 1410 can include a plurality of protection layers 1513a, 1513b and 1514 arranged on the side and upper surface of each of a plurality of drivers DRV, and a plurality of insulating layers 1515a, 1515b and 1515c arranged on the plurality of protection layers 1513a, 1513b and 1514 A bank BNK can be arranged on the plurality of insulating layers.

The plurality of protection layers 1513a, 1513b and 1514 can further include a side protection layer 1513 disposed on each side of the plurality of drivers DRV and an upper protection layer 1514 disposed on the upper surface of each of the plurality of drivers DRV.

The side protection layer 1513 can include a first protection layer 1513a disposed on the substrate 210 and a second protection layer 1513b disposed on the first protection layer 1513a.

The upper protection layer 1514 can include a third protection layer 1514 disposed on the plurality of drivers DRV.

The plurality of insulating layers 1515a, 1515b and 1515c can include a first insulating layer 1515a disposed on the upper protection layer 1514, and a second insulating layer 1515b disposed on the first insulating layer 1515a. The plurality of insulating layers 1515a, 1515b and 1515c can further include a third insulating layer 1515c disposed on the second insulating layer 1515b.

Each of the plurality of light emitting devices EDa, EDb and EDc can be disposed on the bank BNK and positioned in an opening of the first optical layer 1517a.

At least a portion of each of the plurality of column lines CL can extend onto the bank BNK on the plurality of insulating layers 1515a, 1515b and 1515c. Each of the plurality of row lines RL can be arranged on the first optical layer 1517a and the plurality of light emitting devices EDa, EDb and EDc.

A first electrode Ec1 of each of the plurality of light emitting devices EDa, EDb and EDc can be electrically connected to at least a portion of a column line CL extending onto the bank BNK among the plurality of column lines CL. A second electrode Er1 of each of the plurality of light emitting devices EDa, EDb and EDc can be electrically connected to one of the plurality of row lines RL.

The display panel 110 according to the embodiments of the present disclosure can include a plurality of line connection patterns LCPs that connect each of a plurality of lines including a plurality of row lines RL and a plurality of column lines CL to a plurality of drivers DRV.

The plurality of line connection patterns LCPs can include a first line connection pattern LCP1 disposed on a side protection layer 1513, a second line connection pattern LCP2 disposed on an upper protection layer 1514 and electrically connected to the first line connection pattern LCP1 through a hole in the upper protection layer 1514, a third line connection pattern LCP3 disposed on a first insulating layer 1515a and electrically connected to the second line connection pattern LCP2 through a hole in the first insulating layer 1515a, and a fourth line connection pattern LCP4 disposed on a second insulating layer 1515b and electrically connected to the third line connection pattern LCP3 through a hole in the second insulating layer 1515b.

The first line connection pattern LCP1 can be electrically connected to one of the plurality of drivers DRV. The fourth line connection pattern LCP4 can be electrically connected to at least one second electrode Er1 of the plurality of light emitting devices EDa, EDb and EDc, or can be electrically connected to at least one first electrode Ec1 of the plurality of light emitting devices EDa, EDb and EDc.

The side protection layer 1513 arranged on each side of the plurality of drivers DRV can include two or more organic layers.

The first and second protection layers 1513a and 1513b as the side protection layer 1513, the third protection layer 1514 as the upper protection layer 1514, and the first to third insulating layers 1515a, 1515b and 1515c can each be composed of organic layers.

In the above, there have been described the structure and operation related to the display function of the display device 100 according to the embodiments of the present disclosure.

The display device 100 according to the embodiments of the present disclosure can provide not only a display function but also a touch sensing function. Accordingly, hereinafter, it will be described a structure and an operation related to the touch sensing function of the display device 100 according to the embodiments of the present disclosure.

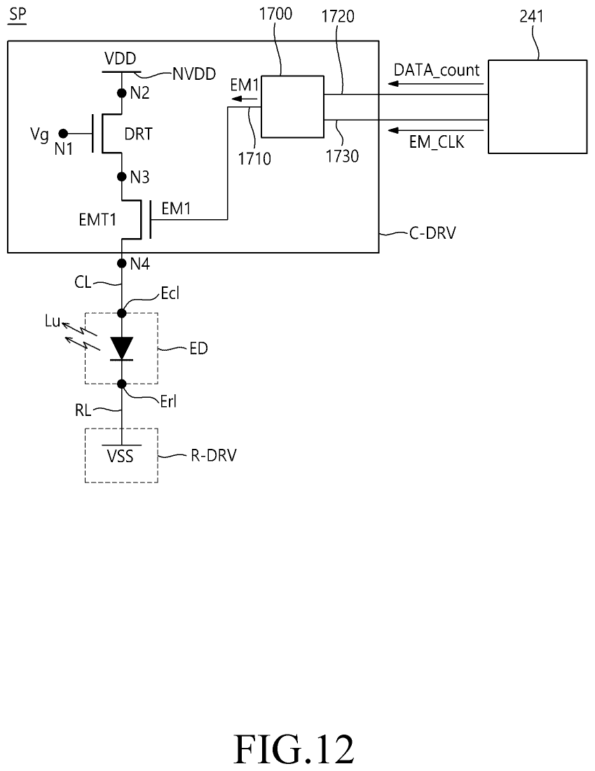

FIG. 12 illustrates a subpixel SP of a display panel 110 according to embodiments of the present disclosure.

The light emitting device ED, the row driver R-DRV, and the column driver C-DRV illustrated in FIG. 12 are the same as the light emitting device ED, the row driver R-DRV, and the column driver C-DRV illustrated in FIG. 5.

Referring to FIG. 12, the column driver C-DRV can further include an emission control signal generation circuit 1700.

The emission control signal generation circuit 1700 can include a first input/output line 1710, a second input/output line 1720, and a third input/output line 1730. The first input/output line 1710 can be a line for outputting an emission control signal EM1. The second input/output line 1720 can be a line for receiving counting data DATA_count. The third input/output line 1730 can be a line for receiving an emission clock signal EM_CLK.

The controller 241 can be electrically connected to the emission control signal generation circuit 1700. The controller 241 can control the operation of the emission control signal generation circuit 1700. The controller 241 can be included in a second circuit component 240 illustrated in FIG. 2.

The controller 241 can supply counting data DATA_count and the emission clock signal EM_CLK to the emission control signal generation circuit 1700.

The counting data DATA_count can include information about the time for which the first emission control signal EM1 maintains a first emission control transistor EMT1 in a turn-on state. The emission clock signal EM_CLK can be a signal that serves as the basis of the first emission control signal EM1.

The emission control signal generation circuit 1700 can generate a first emission control signal EM1 based on the counting data DATA_count and the emission clock signal EM_CLK. Hereinafter, the process of generating the first emission control signal EM1 will be described in more detail.

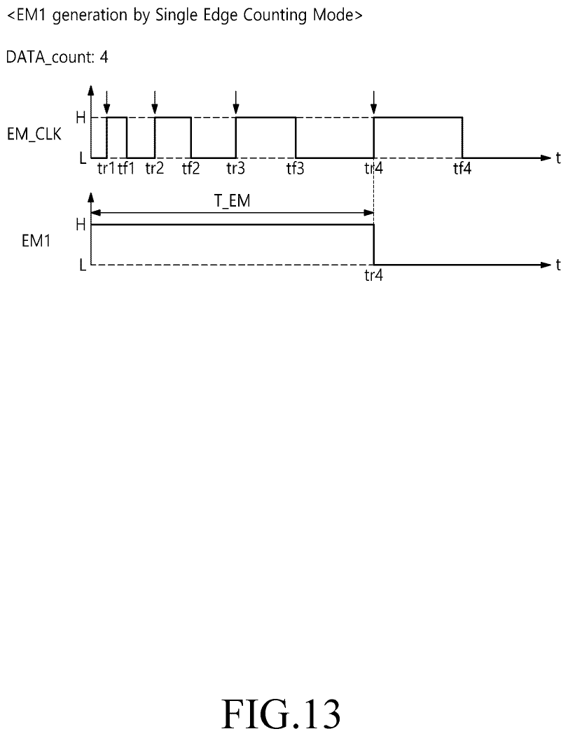

FIG. 13 is a timing diagram for a single edge counting mode according to embodiments of the present disclosure.

The emission clock signal EM_CLK can be an AC (Alternating Current) signal. However, the emission clock signal EM_CLK can be an AC signal with an irregular period. Referring to FIG. 13, the emission clock signal EM_CLK can be an AC signal with an increasing period. The emission clock signal EM_CLK can be a square wave, a triangle wave, a sine wave, etc.

Referring to FIG. 13, multiple rising edge time points tr and multiple falling edge time points tf can be identified.

The emission clock signal EM_CLK can be in a low level state L from the point where the signal starts to a first rising edge time point tr1.

The emission clock signal EM_CLK can be in a high level state H from the first rising edge time point tr1 to a first falling edge time point tf1.

The emission clock signal EM_CLK can be in a low level state L from the first falling edge time point tf1 to a second rising edge time point tr2.

The emission clock signal EM_CLK can be in a high level state H from the second rising edge time point tr2 to a second falling edge time point tf2.

The emission clock signal EM_CLK can be in a low level state L from the second falling edge time point tf2 to a third rising edge time point tr3.

The emission clock signal EM_CLK can be in a high level state H from the third rising edge time point tr3 to a third falling edge time point tf3.

The emission clock signal EM_CLK can be in a low level state L from the third falling edge time point tf3 to a fourth rising edge time point tr4.

The emission clock signal EM_CLK can be in a high level state H from the fourth rising edge time point tr4 to a fourth falling edge time point tf4.

The emission clock signal EM_CLK can be in a low level state L from the fourth falling edge time point tf4.

Referring to FIG. 13, the emission clock signal EM_CLK repeats the high level state H four times, but can also repeat more than four times.

The counting data DATA_count can include information about the time at which the light emitting device ED should emit light.

The counting data DATA_count can include information about the time for which the first emission control transistor EMT1 is maintained in a turned-on state.

The counting data DATA_count can include information about the time for which the first emission control signal EM1 maintains the first emission control transistor EMT1 in a turned-on state.

For example, the counting data DATA_count can be 4. In this case, the high level state H of the first emission control signal EM1 can be maintained until the fourth rising edge time point tr4 of the emission clock signal EM_CLK.

The high level state H of the first emission control signal EM1 can be maintained until the fourth rising edge time point tr4, and then switched to a low level state L.

For example, if the counting data DATA_count is “n”, the high level state H of the first emission control signal EM1 can be maintained until the n-th rising edge time point tm of the emission clock signal EM_CLK. Alternatively, the falling edge can be counted, and the high level state H of the first emission control signal EM1 can be maintained until the n-th falling edge time point tm of the emission clock signal EM_CLK.

The driving method described above can be referred to as a “single edge counting mode”. Hereinafter, a “dual edge counting mode”will be described.

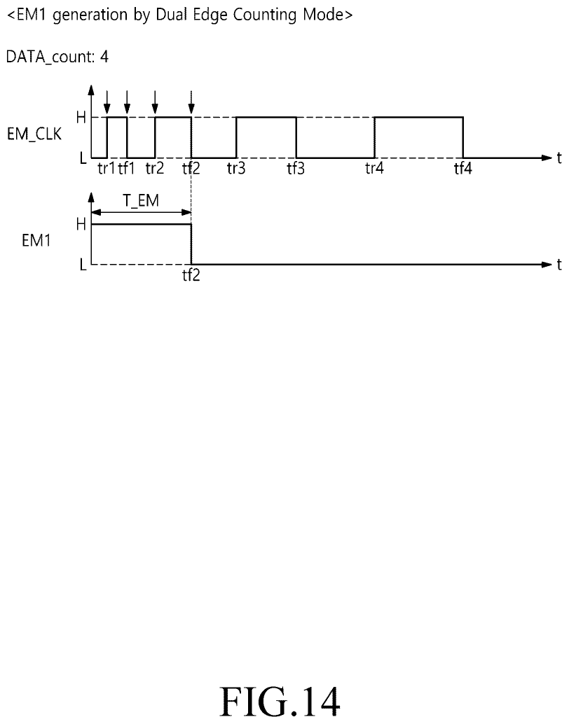

FIG. 14 is a timing diagram for a dual edge counting mode according to embodiments of the present disclosure.

Referring to FIG. 14, the emission clock signal EM_CLK illustrated in FIG. 14 is the same as the emission clock signal EM_CLK illustrated in FIG. 13.

In the dual edge counting mode, the high level state H of the first emission control signal EMI can be maintained until n-th edge times of the emission clock signal EM_CLK. The edge times can include a rising edge time point tr and a falling edge time point tf.

The counting data DATA_count can be 4. In this case, the high level state H of the first emission control signal EM1 can be maintained until the fourth edge times of the emission clock signal EM_CLK. The high level state H of the first emission control signal EM1 can be maintained until the second falling edge time point tf, and then can be switched to a low level state L.

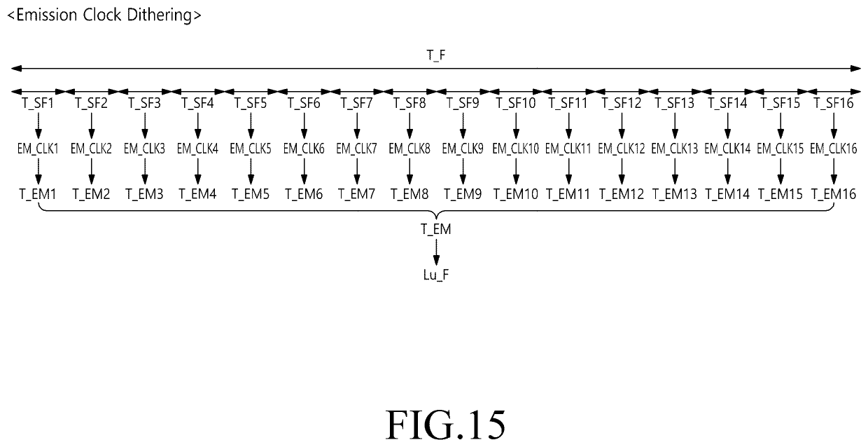

FIG. 15 is a diagram regarding a frame luminance Lu_F of one light emitting device ED for one frame period T_F according to embodiments of the present disclosure.

The frame period T_F can be a period for expressing one image. The frame period T_F can be a period in which one light emitting device ED emits light multiple times.

One frame period T_F can include multiple sub-frame periods T_SF1, . . . , T_SF16. The sub-frame period T_SF can be a period in which one light emitting device ED emits light once and then turns off. Referring to FIG. 15, the number of sub-frame periods T_SF1, . . . , T_SF16 can be 16.

Referring to FIG. 15, the light emitting device ED can emit light during a first emission time T_EM1 based on the first emission clock signal EM_CLK1 in a first sub-frame period T_SF1. The light emitting device ED can emit light during a second emission time T_EM2 based on a second emission clock signal EM_CLK2 in a second sub-frame period T_SF2. The above-described feature can be also applied to the third sub-frame period T_SF3 to the 15-th sub-frame period T_SF15. The light emitting device ED can emit light during a 16-th emission time T_EM16 based on a 16-th emission clock signal EM_CLK16.

A frame emission time T_EM can include the first emission time T_EM1 to the 16-th emission time T_EM16. The light emitting device ED can display the frame luminance Lu_F by emitting light during the frame emission time T_EM.

One frame period T_F can include a plurality of sub-frame periods T_SF1, . . . , T_SF16, and the light emitting device ED can emit light in each of the plurality of sub-frame periods T_SF1, . . . , T_SF16. In order for the light emitting device ED to emit light in each of the plurality of sub-frame periods T_SF1, . . . , T_SF16, an emission clock signal EM_CLK can be individually generated in each of the plurality of sub-frame periods T_SF1, . . . , T_SF16. In each of the plurality of sub-frame periods T_SF1, . . . , T_SF16, an emission clock signal EM_CLK can be generated, and driving the light emitting device ED using the same can be referred to as an “emission clock dithering.” Hereinafter, the “emission clock dithering”will be described in more detail.

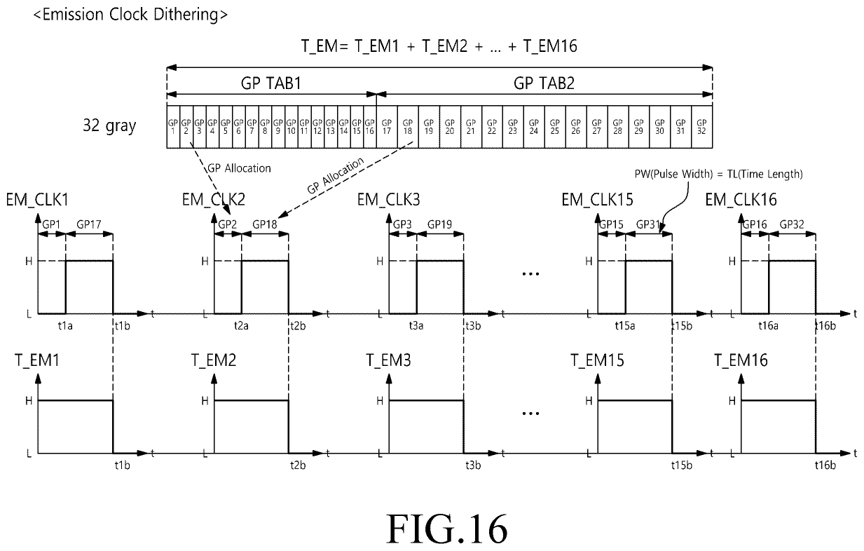

FIG. 16 is a diagram regarding the emission clock dithering according to embodiments of the present disclosure.

Referring to FIG. 16, the light emitting device ED can emit light with a luminance or a brightness for a 32-nd grayscale as the light emitting device ED emits light during the frame emission time T_EM.

The frame emission time T_EM can include the first emission time T_EM1 to the 16-th emission time T_EM16. The first emission time T_EM1 is the period during which the light emitting device ED emits light during the first sub-frame period T_SF1, and the 16-th emission time T_EM16 is the period during which the light emitting device ED emits light during the 16-th sub-frame period T_SF16.

Hereinafter, it will be explained the concept of gamma prime tap GP TAB and the concept of gamma prime GP.

If the specific luminance to be displayed by the light emitting device ED is the 32-nd grayscale, two gamma prime taps GP TAB are required. The number of gamma prime taps GP TAB can be determined by the following method. The number of gamma prime taps GP TAB is a natural number, and the number of gamma prime taps GP TAB can be greater than or equal to “(a specific grayscale)/(the number of sub-frame periods)”. For example, the number of gamma prime taps GP TAB can be the smallest integer greater than or equal to “(a specific grayscale)/(the number of sub-frame periods)”.

For example, if a specific grayscale is a first grayscale and the number of sub-frame periods T_SF is 16, the number of gamma prime taps GP TAB can be 1. If a specific grayscale is a 16-th grayscale and the number of sub-frame periods T_SF is 16, the number of gamma prime taps GP TAB can be 1. If a specific grayscale is the 17-th grayscale and the number of sub-frame periods T_SF is 16, the number of gamma prime taps GP TAB can be 2. If a specific grayscale is the 32-nd grayscale and the number of sub-frame periods T_SF is 16, the number of gamma prime taps GP TAB can be 2. If a specific grayscale is the 33-rd grayscale and the number of sub-frame periods T_SF is 16, the number of gamma prime taps GP TAB can be 3.

A second gamma prime tap GP TAB2 can be longer than a first gamma prime tap GP TAB1. A length of the gamma prime tap GP TAB can correspond to a time length. A longer gamma prime tap GP TAB means a longer frame emission time T_EM. If the light emitting device ED emits light for a longer time, the user perceives it as brighter light.

Each of the gamma prime taps GP TAB can be divided into the number of sub-frame periods T_SF. For example, if the number of sub-frame periods T_SF is 16, the first gamma prime tap GP TAB1 can be divided into 16. In this case, a part of the first gamma prime tap GP TAB1 divided into 16 can be defined as a “gamma prime GP.” A length of the gamma prime GP can correspond to the time length. A long gamma prime GP means that the emission time T_EM is long within one sub-frame period T_SF.

For example, the frame emission time T_EM can be emitted for m unit times. The m unit times can be an exemplary time for the light emitting device ED to express the luminance corresponding to k grayscale. The first gamma prime tap GP TAB1 can correspond to 160 unit times, and the second gamma prime tap GP TAB2 can correspond to 240 unit times. In this case, the first gamma prime tap GP TAB1 can be divided into 16, and each of a first gamma prime GP1 to a 16-th gamma prime GP16 can correspond to 10 unit times. The second gamma prime tap GP TAB2 can be divided into 16, and each of a 17-th gamma prime GP17 to the 32-nd gamma prime GP32 can correspond to 15 unit times.

In the above example, the first gamma prime GP1 can correspond to 10 unit times and the 17-th gamma prime GP17 can correspond to 15 unit times. The size of the unit times of each of the first gamma prime GP1 and the 17-th gamma prime GP17 can be independently determined by a gamma curve.

A first emission clock signal EM_CLK1 can be generated based on the first gamma prime GP1 and the 17-th gamma prime GP17. The first emission clock signal EM_CLK1 can be in a low level state L during a period corresponding to the first gamma prime GP1. The first emission clock signal EM_CLK1 can be in a high level state H during a period corresponding to the 17-th gamma prime GP17, and the first emission clock signal EM_CLK1 can be in a high level state H from a first rising time point t1a to a first falling time point t1b. In this case, the first emission time T_EM1 can be generated based on the first emission clock signal EM_CLK1. The period during which the first emission time T_EM1 is in a high level state H can be maintained until the first falling time point t1b.

A second emission clock signal EM_CLK2 can be generated based on a second gamma prime GP2 and an 18-th gamma prime GP18. The second gamma prime GP2 and the 18-th gamma prime GP18 as the basis of the second emission clock signal EM_CLK2 can be defined as “gamma prime allocation.” The second emission clock signal EM_CLK2 can be in a low level state L during a period corresponding to the second gamma prime GP2. The second emission clock signal EM_CLK2 can be in a high level state H during a period corresponding to the 18-th gamma prime GP18, and the second emission clock signal EM_CLK2 can be in a high level state H from a second rising time point t2a to the second falling time point t2b. In this case, the second emission time T_EM2 can be generated based on the second emission clock signal EM_CLK2. The period during which the second emission time T_EM2 is in a high level state H can be maintained until the second falling time point t2b.

A third emission clock signal EM_CLK3 can be generated based on a third gamma prime GP3 and a 19-th gamma prime GP19. The third emission clock signal EM_CLK3 can be in a low level state L during a period corresponding to the third gamma prime GP3. The third emission clock signal EM_CLK3 can be in a high level state H during a period corresponding to the 19-th gamma prime GP19, and the third emission clock signal EM_CLK3 can be in a high level state H from a third rising time point to a third falling time point. In this case, a third emission time T_EM3 can be generated based on the third emission clock signal EM_CLK3. The period during which the third emission time T_EM3 is in a high level state H can be until the third falling time point t3b.

A 15-th emission clock signal EM_CLK15 can be generated based on a 15-th gamma prime GP15 and the 31-st gamma prime GP31. The 15-th emission clock signal EM_CLK15 can be in a low level state L during the period corresponding to the 15-th gamma prime GP15. The 15-th emission clock signal EM_CLK15 can be in a high level state H during a period corresponding to the 31-st gamma prime GP31, and the 15-th emission clock signal EM_CLK15 can be in a high level state H from the 15-th rising time point to the 15-th falling time point. In this case, the 15-th emission time T_EM15 can be generated based on the 15-th emission clock signal EM_CLK15. The period during which the 15-th emission time T_EM15 is in a high level state H can be until the 15-th falling time point t15b.

A 16-th emission clock signal EM_CLK16 can be generated based on a 16-th gamma prime GP16 and a 32-nd gamma prime GP32. The 16-th emission clock signal EM_CLK16 can be in a low level state L during a period corresponding to the 16-th gamma prime GP16. The 16-th emission clock signal EM_CLK16 can be in a high level state H during a period corresponding to the 32-nd gamma prime GP32, and the 16-th emission clock signal EM_CLK16 can be in a high level state H from a 16-th rising time point to a 16-th falling time point. In this case, the 16-th emission time T_EM16 can be generated based on the 16-th emission clock signal EM_CLK16. The period during which the 16-th emission time T_EM16 is in a high level state H can be until the 16-th falling time point t16b.

The light emitting device ED can emit light during each of the first emission time T_EM1 to the 16-th emission time T_EM16. The frame emission time T_EM can include the first emission time T_EM1 to the 16th emission time T_EM16, and the light emitting device ED can display the frame luminance Lu_F during the frame emission time T_EM. The light emitting device ED can turn on and off repeatedly during the frame emission time T_EM, but the user recognizes that the light emitting device ED emits light with the frame luminance Lu_F.

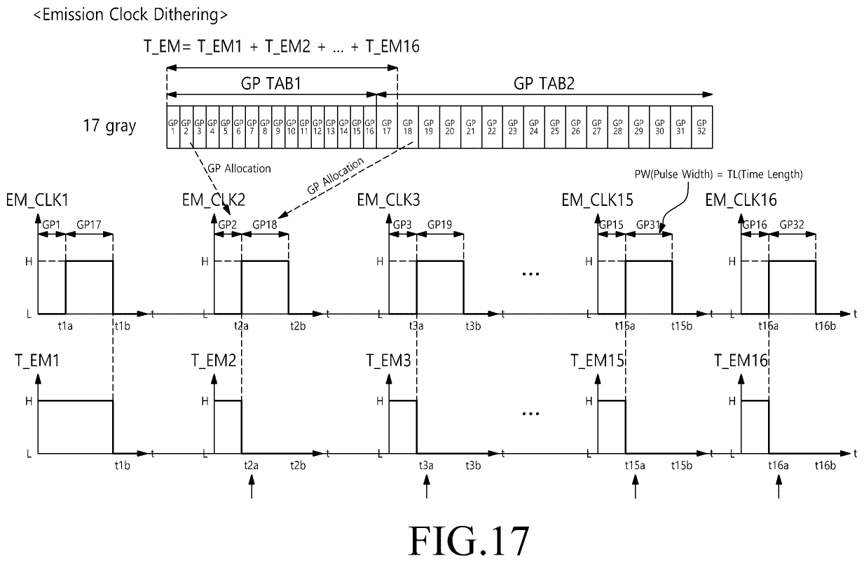

FIG. 17 is a diagram related to emission clock dithering according to embodiments of the present disclosure.

Referring to FIG. 16 and FIG. 17, FIG. 16 illustrates an example of the 32-nd grayscale, and FIG. 17 illustrates an example of the 17-th grayscale.

Referring to FIG. 17, a first emission clock signal EM_CLK1 to a 16-th emission clock signal EM_CLK16 are identical to the first emission clock signal EM_CLK1 to the 16-th emission clock signal EM_CLK16 illustrated in FIG. 16.

For example, if the second gamma prime tap GP TAB2 is generated, the first emission clock signal EM_CLK1 to the 16-th emission clock signal EM_CLK16 also include some of the gamma primes GP included in the second gamma prime tap GP TAB2.

In order to express luminance corresponding to the 17-th grayscale, the light emitting device ED can emit light during the frame emission time T_EM. The frame emission time T_EM can include a first emission time T_EM1 to a 16-th emission time T_EM16. A frame emission period can include a first gamma prime GP1 to a 17-th gamma prime GP17.

The first emission time T_EM1 can be maintained until a period corresponding to the 17-th gamma prime GP17. The first emission time T_EM1 can be maintained until a first falling time point t1b.

A second emission time T_EM2 can be maintained until a period corresponding to the second gamma prime GP2. The second emission time T_EM2 can be maintained until a second rising time point t2a.

A third emission time T_EM3 can be maintained until a period corresponding to the third gamma prime GP3. The third emission time T_EM3 can be maintained until a third rising time point t3a.

A 15-th emission time T_EM15 can be maintained until a period corresponding to a 15-th gamma prime GP15. The 15-th emission time T_EM15 can be maintained until a 15-th rising time point t15a.

A 16-th emission time T_EM16 can be maintained until a period corresponding to a 16-th gamma prime GP16. The 16th emission time T_EM16 can be maintained until a 16-th rising time point t16a.

For example, the first emission time T_EM1 can be longer than the second emission time T_EM2 to the 16-th emission time T_EM16.

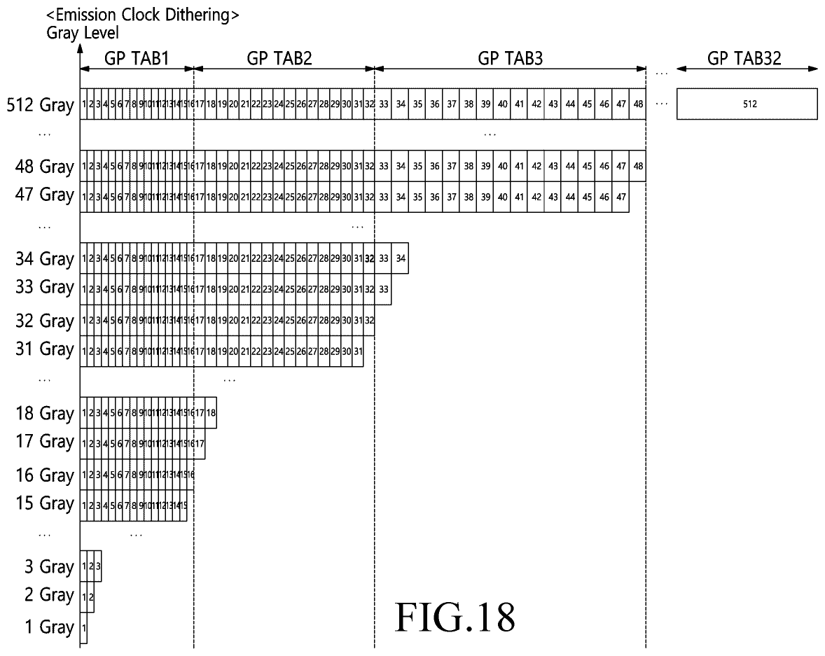

FIG. 18 is a diagram for gamma prime GP for each grayscale according to embodiments of the present disclosure.

Referring to FIG. 18, a first gamma prime tab GP TAB1 is required to express the luminance for a first grayscale (1 Gray) to a 16-th grayscale (16 Gray).

The luminance for the first grayscale (1 Gray) is displayed by the light emitting device ED emitting light during a first gamma prime GP1.

The luminance for a second grayscale (2 Gray) is displayed by the light emitting device ED emitting light during the first gamma prime GP1 to a second gamma prime GP2.

The luminance for a third grayscale (3 Gray) is displayed by the light emitting device ED emitting light during the first gamma prime GP1 to a third gamma prime GP3.

The luminance for the 16-th grayscale (16 Gray) is displayed by the light emitting device ED emitting light during the first gamma prime GP1 to a 16-th gamma prime GP16.

In order to express the luminance for the 17-th grayscale (17 Gray) to the 32-nd grayscale (32 Gray), the first gamma prime tap GP TAB1 to the second gamma prime tap GP TAB2 are required.

The luminance for the 17-th grayscale (17 Gray) is displayed by the light emitting device ED emitting light during the first gamma prime GP1 to a 17-th gamma prime GP17.

The luminance for the 18-th gray scale (18 Gray) is displayed by the light emitting device ED emitting light during the first gamma prime GP1 to a 18-th gamma prime GP18.

The luminance for the 31-st gray scale (31 Gray) is displayed by the light emitting device ED emitting light during the first gamma prime GP1 to a 31-st gamma prime GP31.

The luminance for the 32-nd gray scale (32 Gray) is displayed by the light emitting device ED emitting light during the first gamma prime GP1 to a 32-nd gamma prime GP32.

In order to express the luminance for the 33-rd grayscale (33 Gray) to the 48-th grayscale (48 Gray), the first gamma prime tap GP TAB1 to the third gamma prime tap GP TAB3 are required.

The luminance for the 33-rd grayscale (33 Gray) is displayed by the light emitting device ED emitting light during the 1st gamma prime GP1 to a 33-rd gamma prime GP33.

The luminance for the 34-th grayscale (34 Gray) is displayed by the light emitting device ED emitting light during the 1st gamma prime GP1 to a 34-th gamma prime GP34.

The luminance for the 47-th grayscale (47 Gray) is displayed by the light emitting device ED emitting light during the first gamma prime GP1 to a 47-th gamma prime GP47.

The luminance for the 48-th grayscale (48 Gray) is displayed by the light emitting device ED emitting light during the first gamma prime GP1 to a 48-th gamma prime GP48.

In order to express the luminance for the 512-th grayscale (512 Gray), the first gamma prime tap GP TAB1 to the 32-nd gamma prime tap GP TAB32 are required.

The luminance for the 512-th gray level (512 Gray) is displayed by the light emitting device ED emitting light during the first gamma prime GP1 to a 512-th gamma prime GP512.

Referring to FIGS. 15, 16, and 22, it will be described the emission clock dithering, the gamma prime tap GP TAB, the gamma prime GP. Hereinafter, the gamma prime GP will be described in more detail.

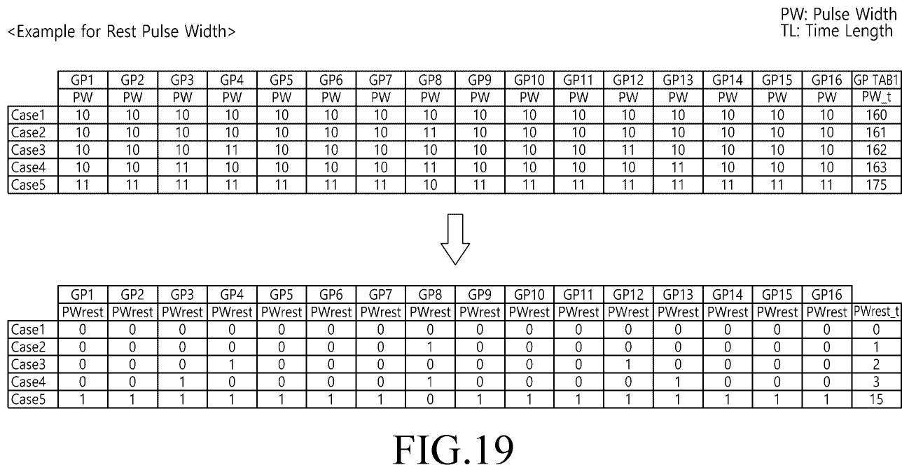

FIG. 19 is an example table regarding gamma primes GP included in the first gamma prime tap GP TAB1 according to embodiments of the present disclosure.

Referring to FIG. 19, a plurality of unit times are illustrated. The unit time can mean “PW”illustrated in FIG. 19, and “PW”can correspond to a length of time (TL, Time Length).

Referring to Case 1 of FIG. 19, the unit time PW_t of the first gamma prime tap GP TAB1 can be 160 unit times. In this case, each of the first gamma prime GP1 to the 16-th gamma prime GP16 can correspond to 10 unit times.

However, referring to Case 2, the unit time PW_t of the first gamma prime tap GP TAB1 can be 161 unit times. In this case, at least one gamma prime GP8 can correspond to 11 unit times, and the remaining gamma primes GP can correspond to 10 unit times. In this case, the 11 unit times are longer by 1 unit time than the 10 unit times, and the 11 unit times being longer by 1 unit time can be defined as a “rest pulse width PWrest.” One sub-frame can be assigned a gamma prime GP including a “rest pulse width PWrest”. In this case, the sub-frame period can become a sub-frame period that emits 1 unit time more light relative to other sub-frame periods.

In Case 3, the unit time PW_t of the first gamma prime tap GP TAB1 can be 162 unit times. In this case, two gamma primes GP4 and GP12 can correspond to 11 unit times, and the remaining gamma primes GPs can correspond to 10 unit times. Two sub-frames can have a rest pulse width PWrest.

In Case 4, the unit time PW_t of the first gamma prime tap GP TAB1 can be 163 unit time. In this case, three gamma primes GP3, GP8 and GP13 can correspond to 11 unit time, and the remaining gamma primes GP can correspond to 10 unit time. The three sub-frames can have a rest pulse width PWrest.

In Case 5, the unit time PW_t of the first gamma prime tap GP TAB1 can be 175 unit time. In this case, 15 gamma primes GPs can correspond to 11 unit time, and the remaining gamma primes GP can correspond to 10 unit time. The 15 sub-frames can have a rest pulse width PWrest. In this case, only one sub-frame period becomes a sub-frame period that emits less light by 1 unit of time relative to other sub-frame periods.

Due to the rest pulse width PWrest, a difference in emission time T_EM between sub-frame periods can occur. This can be perceived as a flicker phenomenon by the user.

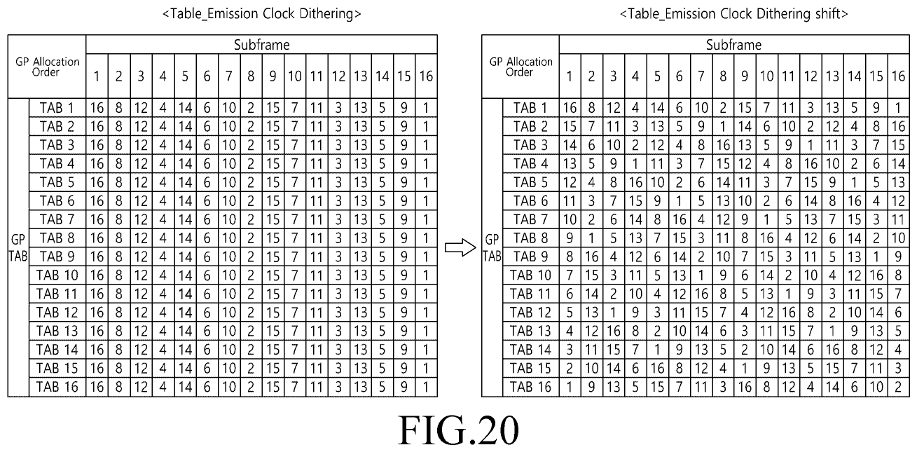

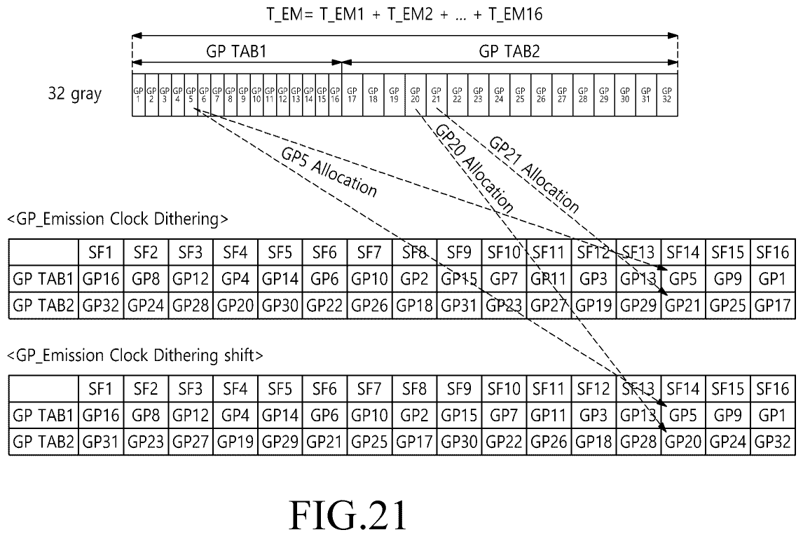

FIGS. 20 and 21 are diagrams regarding the gamma prime allocation order according to embodiments of the present disclosure.

The order in which each sub-frame period is allocated a gamma prime GP can be fixed or variable.

Referring to FIG. 20, referring to a table for emission clock dithering (Table_Emission Clock Dithering), the order in which the gamma prime GP is allocated can be fixed. Referring to a table for the emission clock dithering shift (Table_Emission Clock Dithering Shift), the order in which the gamma primes GP are allocated can be variable or shifted.

First, it will be described a table for emission clock dithering (Table_Emission Clock Dithering). Each of the plurality of sub-frames can have a fixed order of allocation of the gamma primes GP.

The first gamma prime GP1 can be allocated to a 16-th emission clock signal EM CLK16 of a 16-th sub-frame (Subframe 16). The second gamma prime GP2 can be allocated to an 8-th emission clock signal EM_CLK8 of an eighth sub-frame (Subframe 8). The third gamma prime GP3 can be allocated to a 12-th emission clock signal EM_CLK12 of a 12-th sub-frame (Subframe 12). The fourth gamma prime GP4 can be allocated to a fourth emission clock signal EM_CLK4 of a fourth sub-frame (Subframe 4). The fifth gamma prime GP5 can be allocated to a 14-th emission clock signal EM_CLK14 of a 14-th sub-frame (Subframe 14).

The sixth gamma prime GP6 can be allocated to a sixth emission clock signal EM CLK6 of a sixth sub-frame (Subframe 6). The seventh gamma prime GP7 can be allocated to a 10-th emission clock signal EM_CLK10 of a 10-th sub-frame (Subframe 10). The eighth gamma prime GP8 can be allocated to a second emission clock signal EM_CLK2 of a second sub-frame (Subframe 2). The ninth gamma prime GP9 can be allocated to a 15-th emission clock signal EM_CLK15 of a 15-th sub-frame (Subframe 15). The 10-th gamma prime GP10 can be assigned to a seventh emission clock signal EM_CLK7 of a seventh sub-frame (Subframe 7).

The 11-th gamma prime GP11 can be allocated to an 11-th emission clock signal EM_CLK11 of an 11-th sub-frame (Subframe 11). The 12-th gamma prime GP12 can be allocated to a third emission clock signal EM_CLK3 of a third sub-frame (Subframe 3). The 13-th gamma prime GP13 can be allocated to a 13-th emission clock signal EM_CLK13 of a 13-th subframe (Subframe 13). The 14-th gamma prime GP14 can be allocated to a fifth emission clock signal EM_CLK5 of a fifth sub-frame (Subframe 5). The 15-th gamma prime GP15 can be allocated to a ninth emission clock signal EM_CLK9 of a ninth sub-frame (Subframe 9). The 16-th gamma prime GP16 can be allocated to the first emission clock signal EM_CLK1 of the first sub-frame (Subframe 1).

If the order of allocating or assigning gamma primes GP is fixed, there is an advantage of making the design of the display device easier. However, if the order of allocating gamma primes GP is fixed, the sub-frames including the rest pulse width PWrest can be fixedly the same. In this case, a specific sub-frame can include a plurality of rest pulse widths PWrest, and accordingly, the flicker phenomenon can become more severe.

In this case, if the order of allocating gamma primes is varied, the flicker phenomenon can be alleviated.

In the table for the emission clock dithering shift (Table_Emission Clock Dithering Shift) of FIG. 20, there can be identified that the order of allocating gamma primes GP to the first emission clock signal EM_CLK1 of the first sub-frame (Subframe 1) can be 16, 15, 14, . . . 3, 2, 1. For example, the order of allocating gamma primes GP to the first emission clock signal EM_CLK1 can be shifted forward by one. This is the same for the remaining sub-frame periods.

The fact that the emission clock signal EM_CLK of a specific sub-frame is variably allocated a gamma prime GP can be defined as “emission clock dithering shift.” The characteristics of the “emission clock dithering shift”will be further explained below.

There can be identified an example for the 32-nd grayscale (32 Gray). The first gamma prime tap GP TAB1 can include the first gamma prime GP1 to the 16-th gamma prime GP16. The second gamma prime tap GP TAB2 can include the 17-th gamma prime GP17 to the 32-nd gamma prime GP32. The gamma primes GP can be allocated to the emission clock signal EM_CLK for a specific sub-frame.

FIG. 21 illustrates an example of a gamma prime GP of emission clock dithering.

The emission clock signal EM_CLK for a first sub-frame period SF1 is allocated a 16-th gamma prime GP16 for a first gamma prime tap GP TAB1 and a 32-nd gamma prime GP32 for a second gamma prime tap GP TAB2. If a third gamma prime tap is generated, the emission clock signal for the first sub-frame period SF1 is further allocated a 48-th gamma prime. In addition, if a fourth gamma prime tap is generated, the emission clock signal for the first sub-frame period SF1 can be further allocated a 64-th gamma prime.

The emission clock signal EM_CLK for a 14-th sub-frame period SF14 can be further allocated a fifth gamma prime GP5 for the first gamma prime tap GP TAB1 and a 21-st gamma prime GP21 for the second gamma prime tap GP TAB2. If the third gamma prime tap is generated, the emission clock signal for the 14th sub-frame period SF14 can be further allocated a 37-th gamma prime. In addition, if the fourth gamma prime tap is generated, the emission clock signal for the 14-th sub-frame period SF14 can be further allocated a 53-rd gamma prime.

Referring to FIG. 21, there is illustrated an example of a gamma prime GP of an emission clock dithering shift.

The emission clock signal EM_CLK for the first sub-frame period SF1 can be further allocated a 16-th gamma prime GP16 for the first gamma prime tap GP TAB1 and a 31-st gamma prime GP31 for the second gamma prime tap GP TAB2. If the third gamma prime tap is generated, the emission clock signal for the 1st sub-frame period SF1 can be further allocated a 46-th gamma prime. In addition, if the fourth gamma prime tap is generated, the emission clock signal for the first sub-frame period SF1 can be further allocated a 61-st gamma prime.

The emission clock signal EM_CLK for the 14-th sub-frame period SF14 can be allocated a fifth gamma prime GP5 for the first gamma prime tap GP TAB1 and a 20-th gamma prime GP20 for the second gamma prime tap GP TAB2. If the third gamma prime tap is generated, the emission clock signal for the 14-th sub-frame period SF14 can be further allocated a 35-th gamma prime. In addition, if the fourth gamma prime tap is generated, the emission clock signal for the 14-th sub-frame period SF14 can be further allocated a 50-th gamma prime.

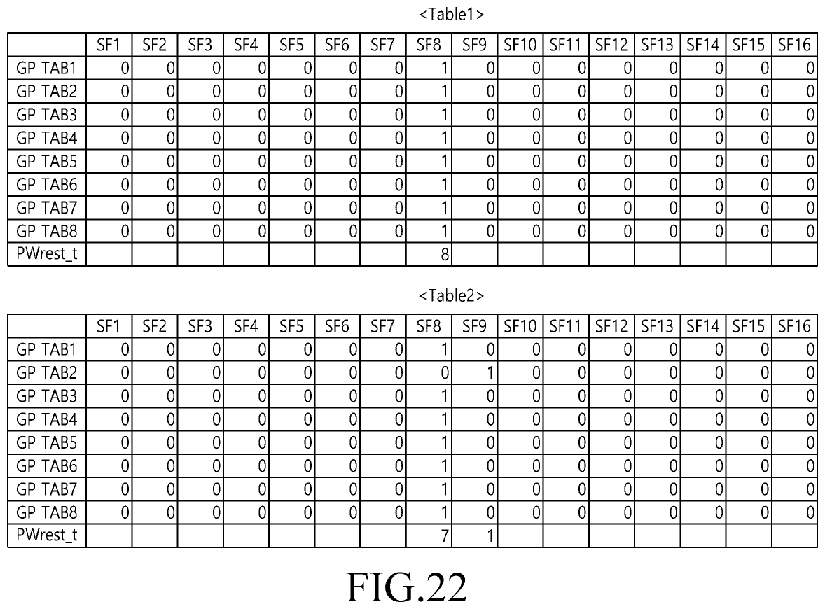

FIG. 22 illustrate tables for explaining the emission clock dithering shift according to embodiments of the present disclosure. FIG. 22 illustrates Table 1 and Table 2.

In the case of Table 1, the eighth emission clock signal EM_CLK8 of the eighth sub-frame period SF8 has one rest pulse width PWrest. In the first gamma prime tap GP TAB1, the rest pulse width PWrest is generated only in the eighth sub-frame period SF8, and there is no rest pulse width PWrest in the remaining sub-frame periods. The same applies to the second gamma prime tap GP TAB2 to the eighth gamma prime tap GP TAB8.

Table 2 is the case where the emission clock dithering shift is performed only once. In the second gamma prime tap GP TAB2, the rest pulse width PWrest is included in the ninth sub-frame period SF9 according to the emission clock dithering shift.

In the case of Table 1, there are 8 rest pulse widths PWrest only in the eighth sub-frame period SF8. In the case of Table 2, there are 7 rest pulse widths PWrest in the eighth sub-frame period SF8, and 1 rest pulse width PWrest in the ninth sub-frame period SF9. For example, the rest pulse width PWrest included in the eighth sub-frame period SF8 can be reduced through the emission clock dithering shift, and/or provide a clear image quality and/or, power consumption can be reduced.

In the case of Table 2, the emission clock dithering shift is applied only once. If applying the emission clock dithering shift multiple times, it is possible to prevent or reduce the phenomenon in which the rest pulse width PWrest is repeatedly included only in a specific sub-frame, and/or provide a clear image quality and/or, power consumption can be reduced.

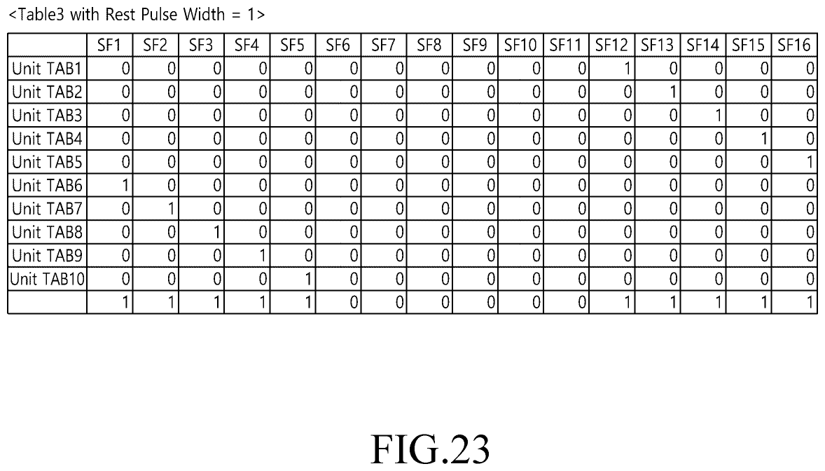

FIG. 23 is a diagram for explaining the emission clock dithering shift according to embodiments of the present disclosure.

The example illustrated in FIG. 23 is an example in which the rest pulse width PWrest is 1.

Referring to the first gamma prime tap GP TAB1, the 12-th sub-frame (Subframe 12) can include the rest pulse width PWrest. Referring to the second gamma prime tap GP TAB2, the 13-th sub-frame period SF13 can include the rest pulse width PWrest. Referring to the third gamma prime tap GP TAB3, the 14-th sub-frame period SF14 includes the rest pulse width PWrest. Referring to the fourth gamma prime tap GP TAB4, the 15-th sub-frame period SF15 includes a rest pulse width PWrest. Referring to the fifth gamma prime tap GP TAB5, the 16-th sub-frame period SF16 includes a rest pulse width PWrest.

Referring to the sixth gamma prime tap GP TAB6, the first sub-frame period SF1 includes a rest pulse width PWrest. Referring to the seventh gamma prime tap GP TAB7, the second sub-frame period SF2 includes a rest pulse width PWrest. Referring to the eighth gamma prime tap GP TAB8, the third sub-frame period SF3 includes a rest pulse width PWrest. Referring to the ninth gamma prime tap GP TAB9, the fourth sub-frame period SF4 includes a rest pulse width PWrest. Referring to the tenth gamma prime tap GP TAB10, the fifth sub-frame period SF5 includes a rest pulse width PWrest.

If the emission clock dithering shift is not applied, there will be 10 rest pulse widths PWrest in the 12-th sub-frame (Subframe 12). Meanwhile, if the emission clock dithering shift is applied, the sub-frame periods can share the rest pulse width PWrest. Accordingly, it is possible to prevent or reduce a flicker phenomenon that can occur as the emission time T_EM of a specific sub-frame becomes longer and/or provide a clear image quality and/or reduce power consumption.

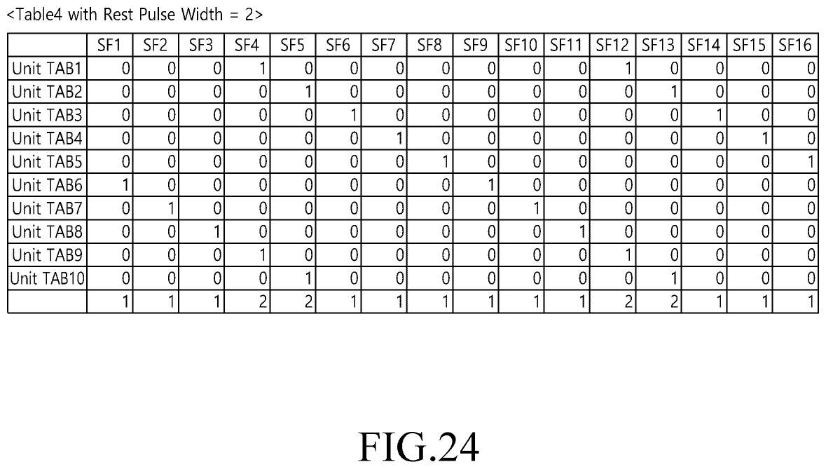

FIG. 24 is a diagram for explaining the emission clock dithering shift according to embodiments of the present disclosure.

The example illustrated in FIG. 24 is an example in which the rest pulse width PWrest is 2.

Referring to the first gamma prime tap GP TAB1, the fourth sub-frame period SF4 and the 12-th sub-frame period SF 12 include the rest pulse width PWrest. Referring to the second gamma prime tap GP TAB2, the fifth sub-frame period SF5 and the 13-th sub-frame period SF13 include a rest pulse width PWrest. Referring to the third gamma prime tap GP TAB3, the sixth sub-frame period SF6 and the 14-th sub-frame period SF14 include a rest pulse width PWrest. Referring to the fourth gamma prime tap GP TAB4, the seventh sub-frame period SF7 and the 15-th sub-frame period SF15 include a rest pulse width PWrest. Referring to the fifth gamma prime tap GP TAB5, the eighth sub-frame period SF8 and the 16-th sub-frame period SF16 include a rest pulse width PWrest.

Referring to the sixth gamma prime tap GP TAB6, the first sub-frame period SF1 and the ninth sub-frame period SF9 include a rest pulse width PWrest. Referring to the seventh gamma prime tap GP TAB7, the second sub-frame period SF2 and the tenth sub-frame period SF10 include a rest pulse width PWrest. Referring to the eighth gamma prime tap GP TAB8, the third sub-frame period SF3 and the 11-th sub-frame period SF11 include a rest pulse width PWrest. Referring to the ninth gamma prime tap GP TAB9, the fourth sub-frame period SF4 and the 12-th sub-frame period SF12 include a rest pulse width PWrest. Referring to the tenth gamma prime tap GP TAB10, the fifth sub-frame period SF5 and the 13-th sub-frame period SF13 include a rest pulse width PWrest.

If the emission clock dithering shift is not applied, there will be 10 rest pulse widths PWrest in the fourth sub-frame period SF4 and the 12th sub-frame period SF 12. Meanwhile, if the emission clock dithering shift is applied, the sub-frame periods can share the rest pulse width PWrest. Accordingly, there can prevent or reduce a flicker phenomenon that can occur as the emission time T_EM of a specific sub-frame becomes longer and/or provide a clear image quality and/or reduce power consumption.

According to embodiments of the present disclosure, it is possible to provide a display device capable of preventing a flicker phenomenon by controlling the emission time of a light emitting device.

According to the embodiments of the present disclosure, it is possible to provide a display device with clear image quality by controlling the emission time of a light emitting device.

According to the embodiments of the present disclosure, it is possible to provide a display device capable of low power consumption by controlling the emission time of a light emitting device.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein can be applied to other embodiments and applications without departing from the spirit and scope of the present invention. The above description and the accompanying drawings provide an example of the technical idea of the present invention for illustrative purposes only. For example, the disclosed embodiments are intended to illustrate the scope of the technical idea of the present invention.

What is claimed is:

1. A display device comprising:
a light emitting device;
a driver configured to drive the light emitting device; and
a controller configured to control the driver and supply a plurality of emission clock signals to the driver,
wherein the plurality of emission clock signals include a first emission clock signal and a second emission clock signal, and
wherein a length of the first emission clock signal is different from a length of the second emission clock signal.

2. The display device of claim 1, wherein each emission clock signal is allocated based on at least one gamma prime (GP),
wherein each of the at least one GP is a part of the a gamma prime tap (GP TAB), equally divided by the number of sub-frames periods in a frame period, and
wherein the number of GP TABs is the smallest integer larger than or equal to a grayscale/the number of sub-frame periods in a frame period.

3. The display device of claim 2, wherein a length of each GP TAB corresponds to an emission time in a frame period, and a length of each of the at least one GP corresponds to an emission time in a sub-frame period.

4. The display device of claim 2, wherein which sub-frame period in one of frame periods is allocated which GP in a GP TAB corresponding to the one of frame periods is variable.

5. The display device of claim 2, wherein a serial number of the GP allocated to each sub-frame period increases or decreases as a serial number of the GP TAB corresponding to the sub-frame period increases.

6. The display device of claim 2, wherein each grayscale corresponds to at least one GP TAB and at least one GP included in the at least one GP TAB.

7. The display device of claim 1, wherein the first emission clock signal includes a first low level period and a first high level period,
wherein the second emission clock signal includes a second low level period and a second high level period, and
wherein a length of the first low level period is different from a length of the second low level period, or a length of the first high level period is different from a length of the second high level period.

8. The display device of claim 7, wherein the first low level period corresponds to a first grayscale,
wherein the second low level period corresponds to a second grayscale greater than the first grayscale,
wherein the first high level period corresponds to a third grayscale greater than the second grayscale, and
wherein the second high level period corresponds to a fourth grayscale greater than the third grayscale.

9. The display device of claim 7, wherein the controller supplies a third emission clock signal among the plurality of emission clock signals to the driver, and
wherein a waveform of the third emission clock signal is identical to a waveform of the first emission clock signal.

10. The display device of claim 9, wherein the controller supplies a fourth emission clock signal among the plurality of emission clock signals, and
wherein a total length of the fourth emission clock signal is equal to a total length of the second emission clock signal.

11. The display device of claim 10, wherein a waveform of the fourth emission clock signal is different from a waveform of the second emission clock signal.

12. The display device of claim 1, wherein each of the plurality of emission clock signals is an AC signal.

13. The display device of claim 2, wherein each of the plurality of emission clock signals is an AC signal whose pulse width increases as a serial number of the GP TAB corresponding to the emission clock signal increases and whose low level state and high level state alternately change.

14. The display device of claim 1, wherein the controller supplies counting data to the driver, and
wherein the driver controls an emission time of the light emitting device based on the plurality of emission clock signals and the counting data.

15. The display device of claim 14, wherein the counting data includes information on the number of times to count edges included in each of the plurality of emission clock signals.

16. The display device of claim 15, wherein the driver counts only a rising edge among the edges.

17. The display device of claim 15, wherein the driver counts a rising edge and a falling edge among the edges.

18. The display device of claim 1, wherein the light emitting device is configured to emit light at a frame luminance in a frame period, and
wherein the frame luminance is equal to a sum of luminance in each of a plurality of sub-frame periods included in the frame period.

19. The display device of claim 1, wherein the driver further includes an emission control transistor that controls an emission time of the light emitting device.

20. The display device of claim 19, wherein the driver further includes an emission control signal generation circuit that supplies an emission control signal to the emission control transistor, and
wherein the emission control signal generation circuit receives the plurality of emission clock signals and counting data from the controller.

21. The display device of claim 1, wherein the driver is disposed in a display area.

22. The display device of claim 1, further comprising:
a substrate including a display area;
a plurality of pixels arranged in the display area and including a plurality of light emitting devices including the light emitting device;
a plurality of column lines electrically connected to a first electrodes of each of the plurality of light emitting devices; and
a plurality of drivers disposed on the substrate, positioned in the display area, and configured to drive the plurality of column lines and a plurality of row lines, the plurality of drivers including the driver,
wherein the plurality of row lines are electrically connected to a second electrode of each of the plurality of light emitting devices.

23. The display device of claim 22, wherein the display area includes a plurality of unit driving areas corresponding to the plurality of drivers,
wherein each of the plurality of unit driving areas includes two or more row lines among the plurality of row lines and two or more column lines among the plurality of column lines, and
wherein each of the plurality of drivers includes:
a row driver configured to drive two or more row lines arranged in a corresponding unit driving area among the plurality of row lines; and
a column driver configured to drive two or more column lines arranged in a corresponding unit driving area among the plurality of column lines.

24. The display device of claim 1, further comprising:
a substrate including a display area;
a layer stack on a plurality of drivers disposed on the substrate;
a first optical layer disposed between a plurality of light emitting devices on the layer stack;
an adhesive layer disposed on the plurality of light emitting devices and the first optical layer; and
a cover member disposed on the adhesive layer,
wherein a plurality of column lines are arranged between the layer stack and the plurality of light emitting devices, and
wherein a plurality of row lines are arranged on the plurality of light emitting devices and the first optical layer.

25. The display device of claim 24, wherein the layer stack includes a side protection layer, an upper protection layer, and a plurality of insulating layers,
wherein the plurality of insulating layers include a first insulating layer on the upper protection layer and a second insulating layer on the first insulating layer,
wherein the layer stack further includes a plurality of line connection patterns connecting each of a plurality of lines including the plurality of row lines and the plurality of column lines to the plurality of drivers,
wherein the plurality of line connection patterns include:
a first line connection pattern disposed on the side protection layer;
a second line connection pattern disposed on the upper protection layer and electrically connected to the first line connection pattern through a hole in the upper protection layer;
a third line connection pattern disposed on the first insulation layer and electrically connected to the second line connection pattern through a hole in the first insulation layer; and
a fourth line connection pattern disposed on the second insulating layer and electrically connected to the third line connection pattern through a hole of the second insulating layer,
wherein the first line connection pattern is electrically connected to one of the plurality of drivers, and
wherein the fourth line connection pattern is electrically connected to a second electrode of at least one of the plurality of light emitting devices, or is electrically connected to a first electrode of at least one of the plurality of light emitting devices.

26. The display device of claim 22, wherein a bank is disposed in each sub-pixel of a plurality of sub-pixels included in each pixel of the plurality of pixels, and the emission device is disposed on the bank, and
wherein the bank of each sub-pixel of the plurality of sub-pixels is separated from each other.

27. The display device of claim 26, wherein each column line of the plurality of column lines includes a column connection electrode which includes a plurality of conductive layers including a first conductive layer disposed on the bank and a second conductive layer disposed on the first conductive layer, and
wherein the second conductive layer has a high reflection efficiency.

28. The display device of claim 27, wherein the plurality of conductive layers further include a third conductive layer including metal and disposed on the second conductive layer and a fourth conductive layer including transparent conductive oxygen and disposed on the third conductive layer, and
wherein a central portion and an edge portion of each of the third and fourth conductive layers remain while other portions of each of the third and fourth conductive layers are removed.

29. The display device of claim 28, wherein the light emitting device includes an encapsulation film disposed on one side of a first electrode and one side of a second electrode of the light emitting device, the encapsulation film including a reflective material.

30. The display device of claim 24, wherein the first optical layer includes an organic insulating material in which fine particles are dispersed.

31. The display device of claim 24, further comprising a third optical layer disposed on the plurality of row lines while overlapping the plurality of emission devices, the third optical layer including an organic insulating material in which fine particles are dispersed.

32. The display device of claim 31, further comprising:
a second optical layer surrounding the first optical layer; and
a black matrix disposed on the plurality of row lines and the second and third optical layers.
